(19) United States
(12) Patent Application Publication
(10) Pub. No.: US 2019/0020980 A1
(43) Pub. Date: Jan. 17, 2019

(54) ELECTRONIC DEVICE AND OPERATION METHOD THEREOF

(71) Applicant: Samsung Electronics Co., Ltd., Gyeonggi-do (KR)

(72) Inventors: Kyungjun LEE, Gyeonggi-do (KR); Youngmi KIM, Seoul (KR); Youngjay LEE, Gyeonggi-do (KR); Hye-Min HA, Gyeonggi-do (KR); Hyunyeul LEE, Seoul (KR)

(21) Appl. No.: 16/068,237

(22) PCT Filed: Dec. 20, 2016
(86) PCT No.: PCT/KR2016/014908

§ 371 Date: Jul. 5, 2018

(30) Foreign Application Priority Data
Jan. 5, 2016 (KR) 10-2016-0001199

(51) Int. Cl. H04W 4/14

(52) U.S. Cl. CPC H04W 4/14

(57) ABSTRACT

An operation method is provided that includes connecting to a relay device via a near field communication; and transmitting, via the relay device, a message to an external device which is previously connected to the relay device via the near field communication. An electronic device is also provided that includes a display unit; a communication unit functionally connected to the display unit; and a control unit functionally connected to the display unit and the communication unit, with the control unit configured to connect to the relay device via the near field communications and transmit, via the relay device, the message to the external device which is previously connected with the relay device by using the near field communication.

### FIELD OF THE INVENTION

Various embodiments of the disclosure relate to an electronic device and an operation method thereof and, for example, relate to an electronic device for exchanging a message with external devices within a specified region, and an operation method thereof

### BACKGROUND

Electronic devices add various functions, to perform a compositive function. For example, the electronic devices can perform a mobile communication function, a data communication function, an image photographing function, a voice recording function, etc. In recent years, the electronic devices can perform a diversity of communication functions by using a device to device (D2D) technology capable of directly communicating among the electronic devices.

### DETAILED DESCRIPTION OF THE INVENTION

### Technological Problem

Various embodiments of the disclosure may provide a communication method of exchanging a message with unidentified external devices within a specified region.

### Means for Solving Problem

An operation method according to various embodiments of the disclosure may include connecting to a relay device by using a near field communication, and transmitting, via the relay device, a message to external devices which are previously connected to the relay device by using the near field communication.

An electronic device according to various embodiments of the disclosure may include a display unit, a communication unit functionally connected with the display unit, and a control unit functionally connected with the display unit and the communication unit. The control unit may be connected to the relay device by using a near field communication, and transmit, via the relay device, a message to external devices which are previously connected with the relay device by using the near field communication.

### Effects of the Invention

Various embodiments of the disclosure may exchange a message among a plurality of unidentified electronic devices in a specified region having a specific range (radius). For example, various embodiments of the disclosure may transmit and/or receive a variety of information between the electronic devices located within the specified region. The electronic device may perform a one-way communication only sending a message, or may perform a two-way communication performing message sending and reception together.

Various embodiments of the disclosure may perform an irregular and non-durable communication, based on anonymity. For example, various embodiments of the disclosure may perform a one-time communication which is inactivated in response to getting out of a specified region.

Various embodiments of the disclosure may receive the sharing of a variety of information from an unidentified external device. Also, various embodiments of the disclosure may process the shared information, and again provide the same to the unidentified external device as well.

### BRIEF DESCRIPTION OF THE DRAWINGS

FIG. 1 and FIG. 2 are diagrams for explaining a communication system according to various embodiments of the disclosure.

FIG. 3 is a signal flow diagram in a communication system according to various embodiments of the disclosure.

FIG. 4 illustrates a block diagram of an electronic device according to various embodiments of the disclosure.

FIG. 5 is a flowchart illustrating a procedure of performing an operation method of an electronic device according to various embodiments of the disclosure.

FIG. 6 to FIG. 14 are example diagrams of a screen of an electronic device according to various embodiments of the disclosure.

FIG. 15 is a flowchart illustrating a procedure of performing a message display operation of FIG. 5.

FIG. 16 is example diagrams of a screen of an electronic device according to various embodiments of the disclosure.

FIG. 17 is a diagram illustrating thread information and message information according to various embodiments of the disclosure.

FIG. 18 to FIG. 19 are example diagrams of a screen of an electronic device according to various embodiments of the disclosure.

FIG. 20 is a block diagram of a relay device according to various embodiments of the disclosure.

FIG. 21 is a flowchart illustrating a procedure of performing an operation method of a relay device according to various embodiments of the disclosure.

FIG. 22 to FIG. 61 are example diagrams of a screen of an electronic device according to various embodiments of the disclosure.

FIG. 62 is a diagram for explaining an operation method of an electronic device according to various embodiments of the disclosure.

FIG. 63 to FIG. 65 are example diagrams of a screen of an electronic device according to various embodiments of the disclosure.

### BEST MODE FOR EMBODIMENT OF THE INVENTION

Hereinafter, various embodiments of the present document are mentioned below with reference to the accompanying drawings. An embodiment and the terms used in this do not intend to limit the technology mentioned in the present document to a specific embodiment form, and should be construed as including various changes of the corresponding embodiment, equivalents thereof, and/or alternatives thereof In the drawings, like reference symbols may denote like constituent elements. The expression of a singular form may include the expression of a plural form unless otherwise dictating clearly in context. In the present document, the expressions “A or B”, “at least one of A and/or B”, etc. may include all available combinations of words enumerated together. The expressions “1st”, “2nd”, “first”, “second”, etc. may modify corresponding constituent elements irrespective of order and/or importance, and are just used to distinguish one constituent element from another constituent element and do not limit the corresponding constituent elements. When it is mentioned that any (e.g., 1st) constituent element is “(operatively or communicatively) coupled with/to” or is “connected to” another (e.g., 2nd) constituent element, the any constituent element may be directly coupled to the another constituent element, or be coupled through a further constituent element (e.g., a third constituent element).

The expression “configured (or set) to˜” used in the present document may be used interchangeably with, for example, “suitable for˜”, “having the capacity to˜”, “designed to˜”, “adapted to˜”, “made to˜”, or “capable of˜” in a hardware or software manner in accordance to circumstances. In any situation, the expression “device configured to˜” may represent that the device is “capable of˜” together with other devices or components. For example, the phrase “processor configured (or set) to perform A, B and C” may represent an exclusive processor (e.g., embedded processor) for performing a corresponding operation, or a generic-purpose processor (e.g., a central processing unit (CPU) or an application processor (AP)) capable of performing corresponding operations by executing one or more software programs stored in a memory device.

An electronic device according to various embodiments of the present document may, for example, include at least one of a smartphone, a tablet personal computer (PC), a mobile phone, a video phone, an electronic book reader, a desktop PC, a laptop PC, a netbook computer, a workstation, a server, a portable digital assistant (PDA), a portable multimedia player (PMP), an MPEG-1 audio layer-3 (MP3) player, a medical device, a camera or a wearable device. The wearable device may include at least one of an accessory type (e.g., a watch, a ring, a wristlet, an anklet, a necklace, glasses, a contact lens or a head-mounted-device (HMD)), a fabric or clothing integrated type (e.g., electronic clothes), a human-body mount type (e.g., a skin pad or tattoo) or a bio implantation type (e.g., an implantable circuit). According to certain embodiment, the electronic device may, for example, include at least one of a television (TV), a digital versatile disc (DVD) player, an audio system, a refrigerator, an air conditioner, a cleaner, an oven, a microwave, a washing machine, an air cleaner, a set-top box, a home automation control panel, a security control panel, a media box (for example, Samsung HomeSync™, Apple TV™ or Google TV™), a game console (e.g., Xbox™ or PlayStation™), an electronic dictionary, an electronic locking system, a camcorder or an electronic frame.

In another embodiment, the electronic device may include at least one of various medical devices (e.g., various portable medical measurement devices (e.g., a blood glucose sensor, a heat rate sensor, a blood pressure monitor, a body temperature meter, etc.), magnetic resonance angiography (MRA), magnetic resonance imaging (MRI), computed tomography (CT), a imaging equipment, an ultrasonic instrument, etc.)), a navigation device, a global navigation satellite system (GNSS), an event data recorder (EDR), a flight data recorder (FDR), a car infotainment device, an electronic equipment for ship (e.g., a vessel navigation device, a gyro compass, etc.), avionics, a security device, a car head unit, an industrial or domestic robot, a drone, an automatic teller's machine (ATM) of a financial institution, point of sales (POS) of shops, an internet of things (IoT) device (e.g., an electric bulb, various sensors, a sprinkler device, a fire alarm, a thermostat, a streetlight, a toaster, an exerciser, a hot water tank, a heater, a boiler, etc.). According to certain embodiment, the electronic device may include at least one of a part of furniture, a building/structure or a car, an electronic board, an electronic signature receiving device, a projector or various metering devices (e.g., tap water, electricity, gas, radio wave metering devices or the like). In various embodiments, the electronic device may be flexible, or be a combination of two or more of the aforementioned various devices. The electronic device according to an embodiment of the present document is not limited to the aforementioned devices. In the present document, the term ‘user’ may denote a person who uses the electronic device or a device (e.g., an artificial-intelligent electronic device) which uses the electronic device.

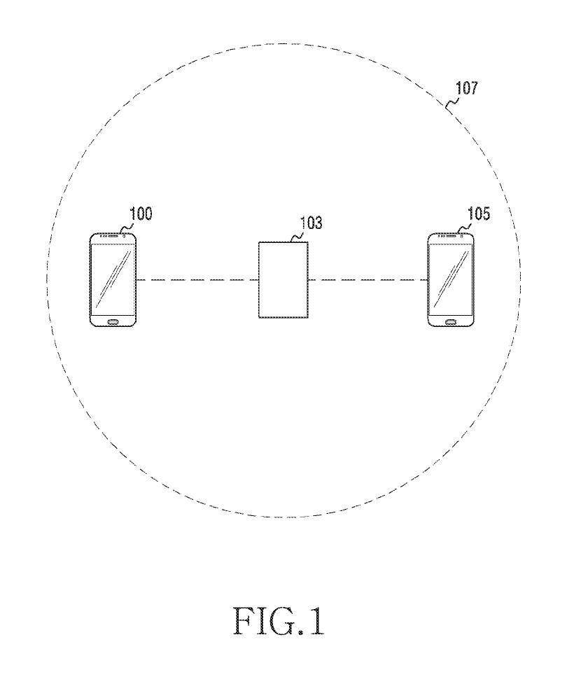

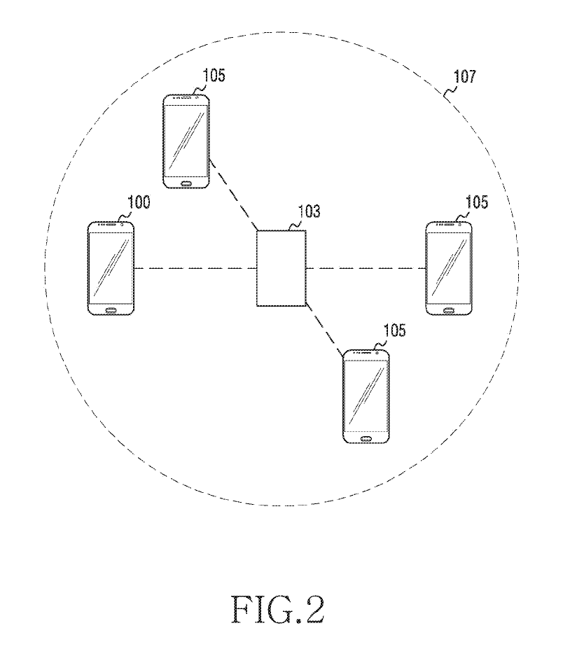

FIG. 1 and FIG. 2 are diagrams for explaining a communication system according to various embodiments of the disclosure.

As illustrated in FIG. 1 and FIG. 2, according to various embodiments, an electronic device 100 may be located within a specified region 107 having a specific range (radius). The specified region 107, which is a coverage region of a relay device 103, may be a region where a near field communication is possible through the relay device 103. The relay device 103 may, for example, include various wireless communication sharers capable of performing AP connection, WiFi sharers, routers or the like. This relay device 103 may define the specified region 107 whose range is identified. And, external devices 105 may be located in the specified region 107, and the electronic device may exchange a message with the external devices 105. The electronic device 100 may exchange a message with one external device 105 or a plurality of external devices 105. The electronic device 100 and the external devices 105 that are located within the specified region 107 may transmit and/or receive a variety of information through the message. In the specified region 107, the electronic device 100 may exchange a message with the plurality of external devices 105, even without identification data of the external devices 105. Meantime, a communication function of exchanging a message with the external devices 105 whose identification data are not identified within the specified region 107 whose range is identified is defined as ‘Broadcasting’.

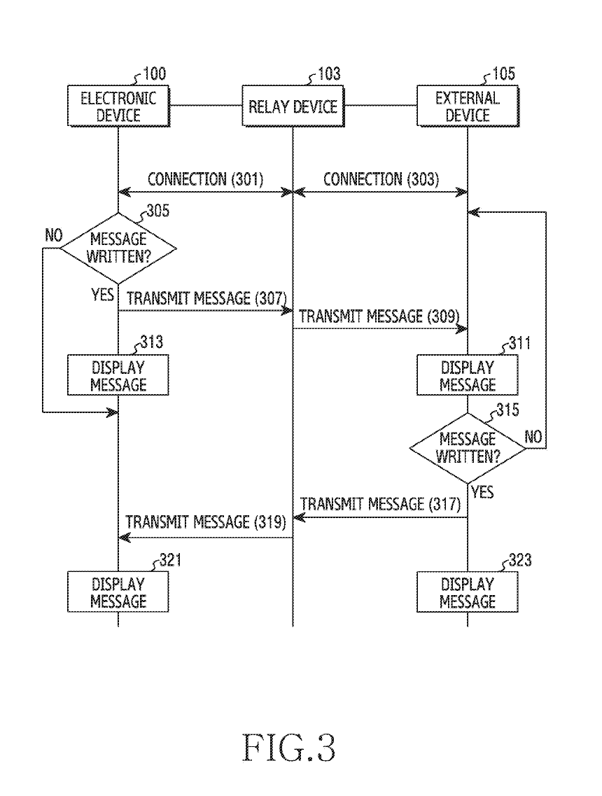

FIG. 3 is a signal flow diagram in a communication system according to various embodiments of the disclosure.

As illustrated in FIG. 3, the electronic device 100 may be connected (301) with the relay device 103. Also, the external device 105 may be connected (303) with the relay device 103. At connection with the relay device 103, the electronic device 100 may transmit identification data of the electronic device 100 to the relay device 103 Similarly with this, at connection with the relay device 103, the external device 100 may transmit identification data of the external device 105 to the relay device 103. This identification data may be, for example, an international mobile equipment identify (IMEI) that is a unique number granted to each device. The relay device 103 may store the identification data of the connected electronic device 100 and external device 105. In response to there being a message sending request from the electronic device 100 or the external device 105, the relay device 103 may send a message to the electronic device 100 or external device 105 connected with the relay device 103, by using the stored identification data.

The electronic device 100 and the external device 105 may be located within the specified region 107. In operation 305, the electronic device 100 may identify whether to write a message. In response to identifying to write the message, in operation 307, the electronic device 100 may transmit the written message. The relay device 103 may identify whether the received message includes a destination. In response to identifying that the received message does not include the destination, in operation 309, the relay device 103 may send the message to the external device 105. In operation 313, the electronic device 100 may display the sent message. In operation 311, the external device 105 may display the received message. In response to identifying not to write the message in operation 305, the electronic device 100 may sense whether it receives a message from the external device 105.

Meantime, in operation 315, the external device 105 may identify whether to write a message. In response to identifying to write the message, in operation 317, the electronic device 100 may transmit the written message. The relay device 103 may identify whether the received message includes a destination. In response to identifying that the received message does not include the destination, in operation 319, the relay device 103 may send the message to the electronic device 100. In operation 323, the external device 105 may display the sent message. In operation 321, the electronic device 100 may display the received message.

The electronic device 100 may perform a one-way communication only sending a message, or may perform a two-way communication performing message sending and message reception together. The electronic device 100 may perform an irregular and non-durable communication, based on anonymity. That is, the electronic device 100 may perform a one-time communication which is inactivated in response to getting out of the specified region 107.

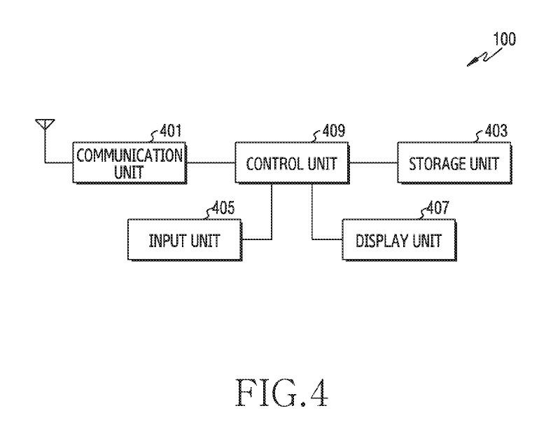

FIG. 4 illustrates a block diagram of an electronic device according to various embodiments of the disclosure.

As illustrated in FIG. 4, the electronic device 100 according to various embodiments may include a communication unit 401, a storage unit 403, an input unit 405, a display unit 407, and a control unit 409. The electronic device 100 according to various embodiments may send a message to the external devices 105 whose identification data are not identified within the specified region 107 whose range is identified, and receive a message from the external devices 105 whose identification data are not identified. That is, the electronic device 100 according to various embodiments may perform a broadcasting function.

The communication unit 401 may perform a wireless communication in the electronic device 100. The communication unit 401 may communicate with the external device 105 in diverse communication schemes. For example, the external device 105 may include the electronic device, the relay device 103, a base station, a server, and a satellite. For this, the communication unit 401 may access at least any one of a mobile communication network, a data communication network, or a near field communication network. For example, the communication scheme may include at least any one of long term evolution (LTE), LTE-advance (LTE-A), code division multiple access (CDMA), wideband code division multiple access (WCDMA), universal mobile telecommunications system (UMTS), wireless broadband (WiBro), global system for mobile communications (GSM), wireless fidelity (WiFi), Bluetooth (BT), near field communications (NFC), global navigation satellite system (GNSS), etc.

Meantime, the communication unit 401 may include a GPS receiving unit (not shown) as well. The GPS receiving unit may receive a position of the electronic device 100 by using a global positioning system (GPS). The GPS receiving unit may include, instead of the GPS, at least any one of a global navigation satellite system (Glonass), Beidou navigation satellite system (hereinafter, referred to as “Beidou”) or the European global satellite-based navigation system (Galileo).

The storage unit 403 may store operation programs of the electronic device 100. The storage unit 403 may store a plurality of functions. The storage unit 403 may store a program for exchanging a message with the external devices 105 whose identification data are not identified within the specified region 107 whose range is identified. That is, the storage unit 403 may store a program for performing broadcasting. The storage unit 403 may store data that are provided in course of execution of the programs. The storage unit 403 may store information included in the message. The information attached to the message may be thread information and message information. Accordingly, the storage unit 403 may store the thread information and message information which are attached to the sent message or received message.

The input unit 405 may provide input data in the electronic device 100. The input unit 405 may provide input data, correspondingly to a user input of the electronic device 100. For example, the input unit 405 may include a key pad, a dome switch, a physical button, a touch panel, a jog & shuttle, and a sensor. The input unit 405 may be coupled with the display unit 407 and be implemented as a touch screen. The input unit 405 may be coupled with the display unit 407 including a touch sensor and a pressure sensor and be implemented as a pressure sensitive touch screen as well.

The display unit 407 may output display data in the electronic device 100. The display data may represent information which is processed in the electronic device 100. For example, the display unit 407 may include at least any one of a liquid crystal display (LCD), a light emitting diode (LED) display, an organic LED (OLED) display, a micro electro mechanical systems (MEMS) display, and an electronic paper display.

The control unit 409 may control a general operation in the electronic device 100. At this time, the control unit 409 may perform various functions. For the sake of this, the control unit 409 may control constituent elements of the electronic device 100. And, the control unit 409 may receive a command or data from the constituent elements of the electronic device 100, and process the received command or data. The control unit 409 may control a general operation for exchanging a message with the external devices 105 whose identification data are not identified, within the specified region 107 whose range is identified. That is, the control unit 409 may control a general operation for performing broadcasting.

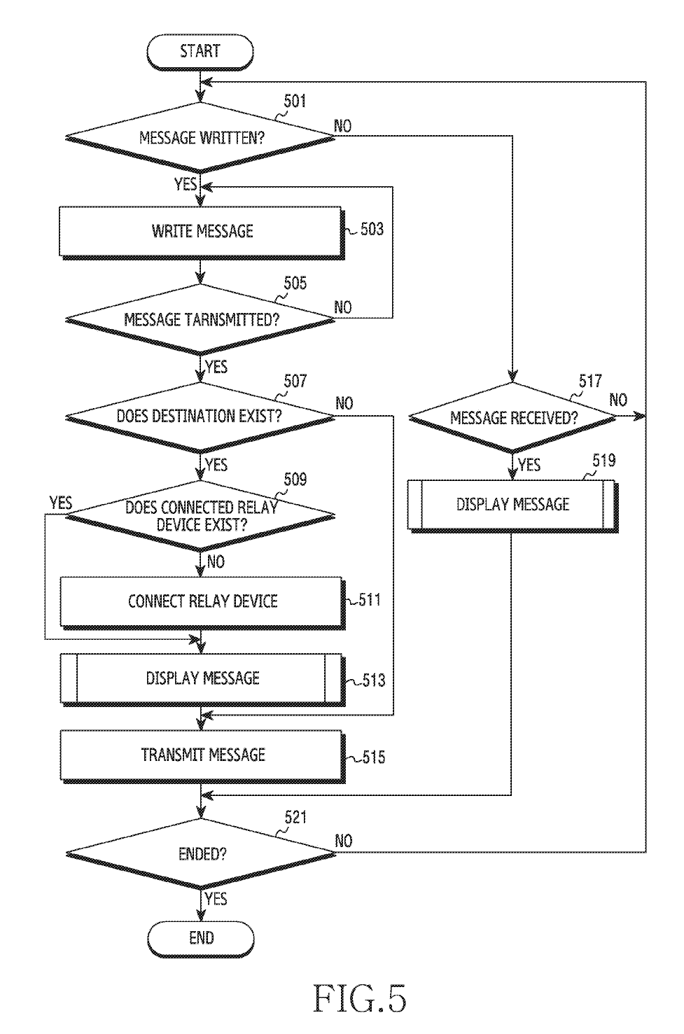

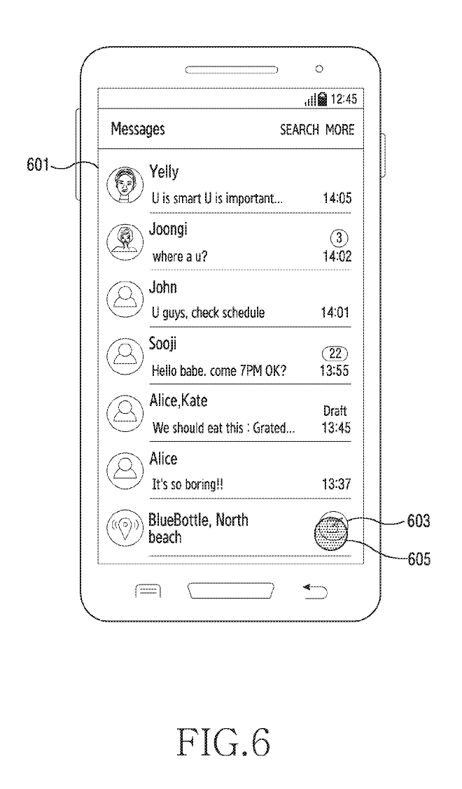

FIG. 5 is a flowchart illustrating a procedure of performing an operation method of an electronic device according to various embodiments of the disclosure. FIG. 6 to FIG. 14 are example diagrams of a screen of the electronic device according to various embodiments of the disclosure.

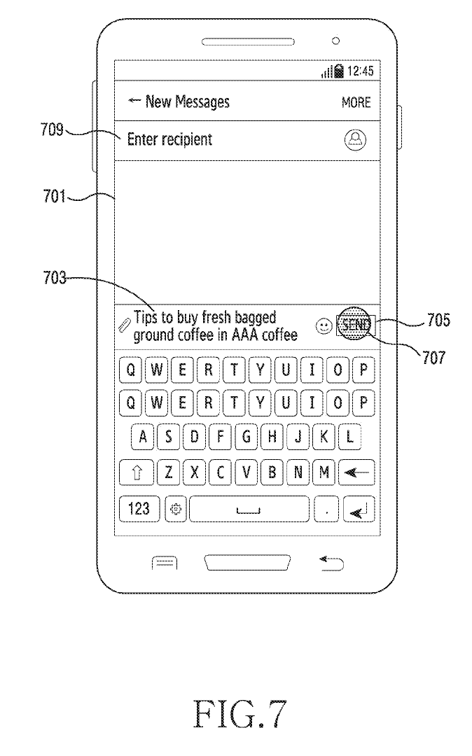

As illustrated in FIG. 5, in operation 501, the control unit 409 may identify whether to write a message. In response to sensing a message writing request, the control unit 409 may identify to write a message. The control unit 409 may sense a user input for writing a message through the input unit 405. For example, in response to sensing the message writing request, as illustrated in FIG. 6, the control unit 409 may display a message application screen 601 on the display unit 407. An icon 603 for new message writing may be displayed on the message application screen 601, and the control unit 409 may sense an input 605 on this icon 603. In response to the input 605 for message writing being provided, as illustrated in FIG. 7, the control unit 409 may display a message writing screen 701.

Next, in operation 503, the control unit 409 may write a message. The control unit 409 may write the message through the input unit 405. For example, as illustrated in FIG. 7, the control unit 409 may display the message writing screen 701 on the display 701. The message writing screen 701 may display a message display window 703 for displaying an inputted message and a destination display window 709 of displaying a destination. The control unit 409 may sense user input provision, and display a written message in the message display window 703.

Next, in operation 505, the control unit 409 may sense a message sending request. The control unit 409 may sense user input provision for sending a message through the input unit 405. For example, as illustrated in FIG. 7, a send icon 705 for message sending may be displayed on the message writing screen 701, and the control unit 409 may sense an input 707 on this send icon 705.

In response to the input 707 for message sending being provided, in operation 507, the control unit 409 may identify whether a destination exists in the message. For example, the control unit 409 may identify whether the message includes the destination through identification information included in the message. In response to the message not including the destination, the message may include first identification information indicating that there is not the destination. Meantime, in response to the message including the destination, the message may include second identification information indicating that there is the destination. In response to sensing a message sending request, the control unit 409 may identify whether the written message includes which identification information. That is, in response to identifying that the written message includes the first identification information, the control unit 409 may identify that the destination does not exist in the message. In response to identifying that the written message includes the second identification information, the control unit 409 may identify that the destination exists in the message.

In response to the destination existing in the written message, the control unit 409 may, in operation 515, send the message to the destination. At this time, the control unit 409 may send the message without identifying connection or non-connection with the relay device 103.

Meantime, in response to the written message not including the destination, the control unit 409 may, in operation 509, identify whether the relay device 103 previously connected through the communication unit 401 exists. That is, the control unit 409 may identify whether the electronic device 100 is located within the specified region 107 and is connected with the relay device 103.

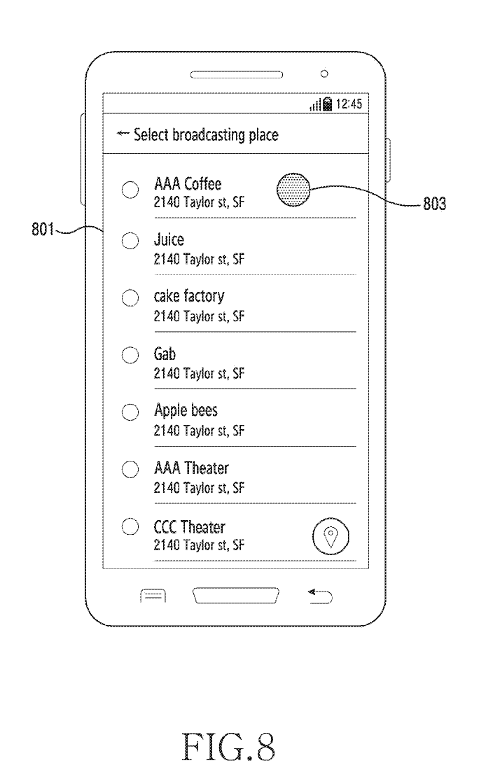

In response to the previously connected relay device 103 not existing, in operation 511, the control unit 409 may perform a connection with the relay device 103. At this time, as illustrated in FIG. 8, the control unit 409 may output a connectable relay device list 801 and display the same on the display unit 407. The relay device list 801 may include the relay devices 103 defining the specified region 107. For example, the relay device 103 may be located in a shop to which a point where the electronic device 101 is located belongs, or a shop around it. The connectable relay device list 801 may include the relay device 103 from which the electronic device 100 receives a signal. Or, the connectable relay device list 801 may include the relay device 103 previously selected. That is, the control unit 409 may previously set the relay device 103 intended to be connected, and the connectable relay device list 801 may include the relay device 103 selected through setting. Or, the connectable relay device list 801 may include an AP which considers a signal received from the relay device 103 and a position of the electronic device 100 identified through the communication unit 401, together. That is, the control unit 409 may output a connectable AP list 801 in consideration of the position of the electronic device 100 acquired through the GPS receiving unit of the communication unit 401. For example, the control unit 409 may identify the matching or non-matching of the specified region 107 (shop) indicated by the AP receiving the position and signal of the electronic device 100. The signal received from the relay device 103 may include position information defining the specified region 107, and the control unit 409 may output the connectable relay device list 801 through this position information and the position of the electronic device 100 identified through the GPS receiving unit.

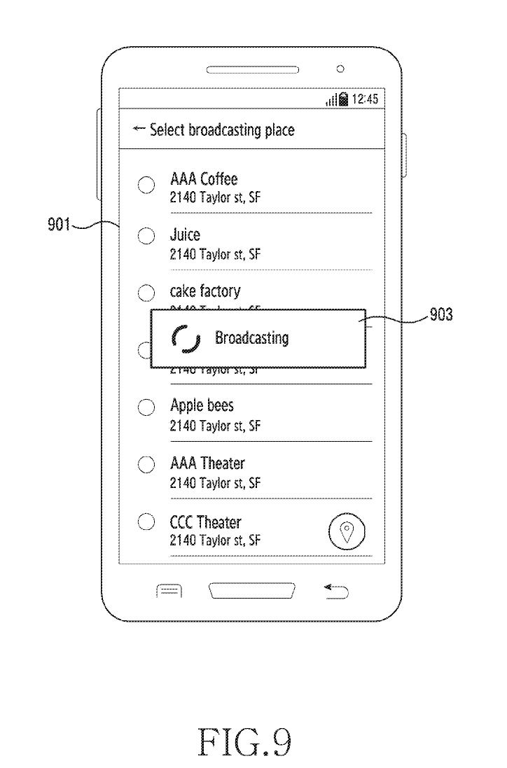

The control unit 409 may sense an input 803 for selection among the displayed relay device list 801. For example, in response to sensing the input 803 of selecting ‘AAA Coffee’ among the displayed relay device list 801, the control unit 409 may perform a connection with the relay device 103 defining the specified region 107 of shop ‘AAA Coffee’. As illustrated in FIG. 9, the control unit 409 may display a screen 901 showing that it is performing a connection with the selected relay device 103 through the display unit 407. The control unit 409 may display a ‘Broadcasting’ start message 903 in order to show a broadcasting start within the screen 901 showing that it is performing the connection with the relay device 103.

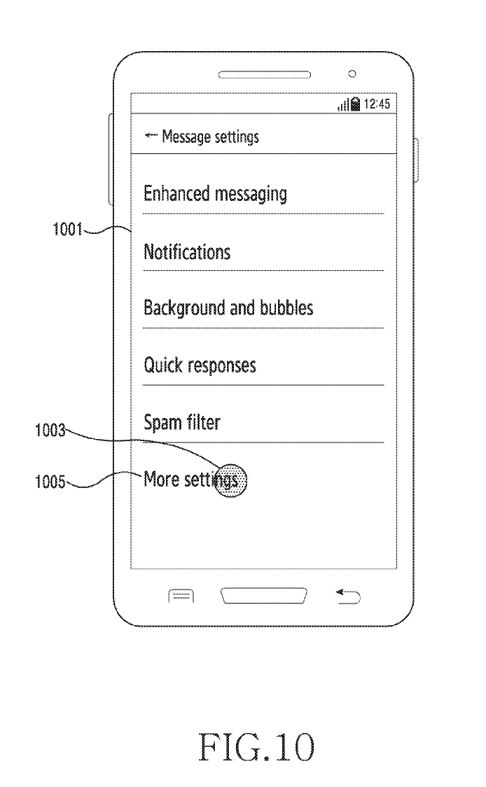

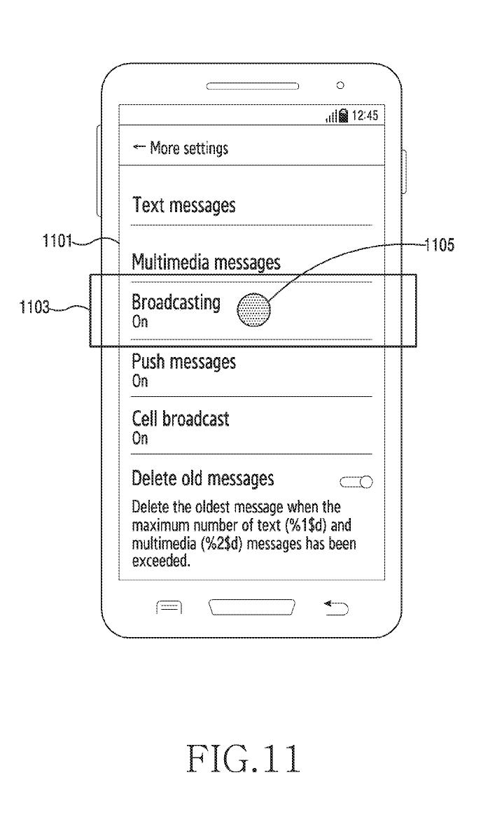

Meantime, the control unit 409 may previously set the specified region 107 for performing broadcasting. That is, the control unit 408 may previously designate the relay device 103 that intends to perform broadcasting. For example, as illustrated in FIG. 10, the control unit 409 may receive an input 1003 of selecting a ‘More settings’ function 1005 on a setting screen 1001 displaying various setting functions. Next, as illustrated in FIG. 11, the control unit 409 may receive an input 1105 of selecting a ‘Broadcasting’ function 1103 on the ‘More settings’ screen 1101 displaying other various functions.

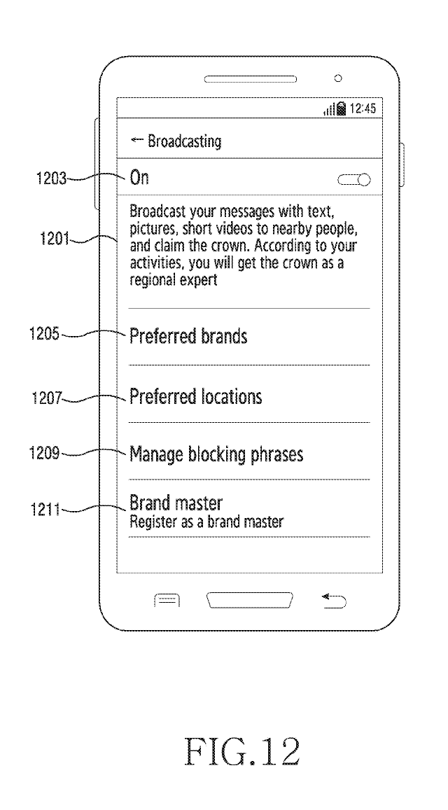

Next, as illustrated in FIG. 12, the control unit 409 may display various functions related with broadcasting on a screen 1201 for setting the broadcasting. For example, the screen 1201 for setting the broadcasting may display an activation function 1203, a ‘Preferred brands’ function 1205, a ‘Preferred locations’ function 1207, a ‘Manage blocking phrases’ function 1209, a ‘Brand master’ function 1211, and the like. The activation function 903 is a function for selecting whether to activate broadcasting. That is, the control unit 409 may select On or Off of the broadcasting through a user input. The ‘Preferred brands’ function 905 is a function for selecting a preferred brand at broadcasting. That is, the control unit 409 may select On or Off of a brand for performing the broadcasting through a user input.

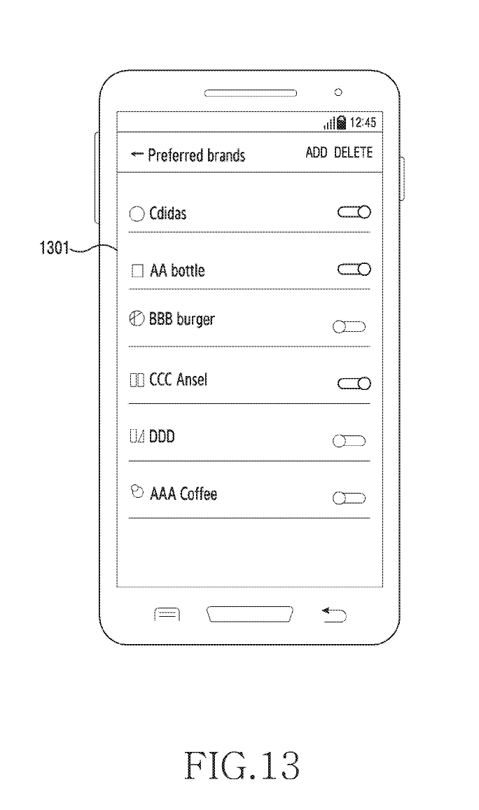

For example, in response to sensing an input of selecting the ‘Preferred brands’ function 905, as illustrated in FIG. 13, the control unit 409 may output and display a brand name list 1301. The control unit 409 may select whether to activate broadcasting in the specified region 107 (for example, a specified brand shop) related with each brand through a user input. That is, the control unit 409 may select On or Off of the broadcasting for each brand included in the brand name list 1301 outputted through the user input. Meantime, in response to a brand set as Off existing, the control unit 409 may not perform a connection with the relay device 103 related with the corresponding brand. That is, the control unit 409 may not perform the broadcasting in the specified region 107 related with the brand set as Off. Accordingly, in FIG. 8, at relay device list 801 output, the control unit 409 may not output the relay device 103 related with the corresponding brand. The control unit 409 may output only the relay devices 103 related with a brand set as On, and display the same on the display unit 407. That is, the control unit 409 may perform the broadcasting in the specified region 107 related with the brand set as On.

The ‘Preferred locations’ function 907 is a function for selecting a preferred space or preferred area at broadcasting. That is, the control unit 409 may select the specified region 107 for performing the broadcasting through a user input. Similarly with the above-described ‘Preferred brands’ function 1205, in response to sensing an input of selecting the ‘Preferred locations’ function 1207, the control unit 409 may output a list of the specified regions 107. The control unit 409 may select whether to activate broadcasting in the specified region 107 related with a specified area, through a user input. That is, the control unit 409 may select On or Off of the broadcasting for each of names included in an outputted area name list 1301 of the specified region 107 through the user input. Meantime, in response to the specified region 107 set as Off existing, the control unit 409 may not perform a connection with the relay device 103 related with the specified region 107 set as Off. The control unit 409 may not perform broadcasting in the specified region 107 set as Off. Accordingly, in FIG. 8, at relay device list 801 output, the control unit 409 may not output the relay device 103 related with the specified region 107 set as Off. That is, the control unit 409 may output only the relay devices 103 related with the specified region 107 set as On, and display the same on the display unit 407. That is, the control unit 409 may perform the broadcasting in the specified region 107 set as On.

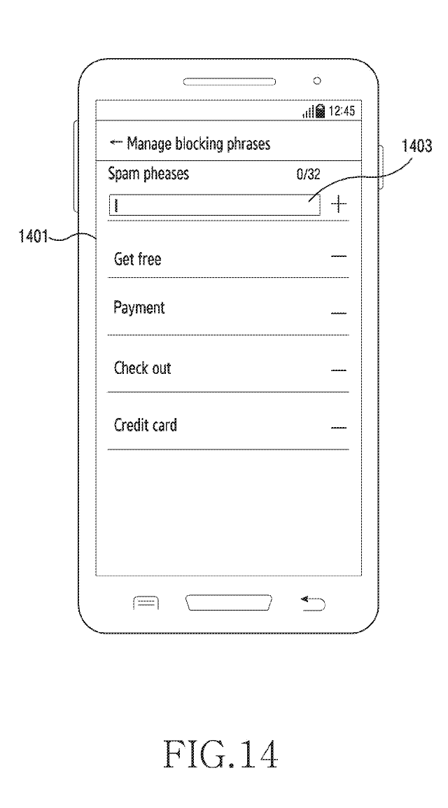

The ‘Manage blocking phrases’ function 1209 is a function for blocking message reception including a specified phrase in course of the execution of the broadcasting. That is, the control unit 409 may designate a specified phrase through a user input. For example, in response to sensing an input of selecting the ‘Manage blocking phrases’ function 1209, as illustrated in FIG. 14, the control unit 409 may display a ‘Manage blocking phrases’ function screen 1401. The control unit 409 may display a text input window 1403 for receiving an input of a specified phrase on the ‘Manage blocking phrases’ function screen 1401. The control unit 409 may block a reception of a message including a phrase received through the input unit 405, in course of the execution of the broadcasting. The ‘Brand master’ function 1211 is a function of registering the electronic device 100 as a master of a specified brand or specified shop. That is, in response to the ‘Brand master’ function 1211 being selected through a user input, the control unit 409 may register the electronic device 100 as the master of the specified brand or specified shop. In response to being registered as the master, the electronic device 100 may transmit a variety of information (for example, corresponding brand advertisement, event, coupon, etc.) to the external device 105 that takes part in broadcasting.

Meantime, referring again to FIG. 5, in response to the relay device 103 for broadcasting being connected, in operation 513, the control unit 409 may display a thread or message through the display unit 407. Or, in response to it being identified that the previously connected relay device 103 exists in operation 509, the control unit 409 may, in operation 513, display a thread or message through the display unit 407.

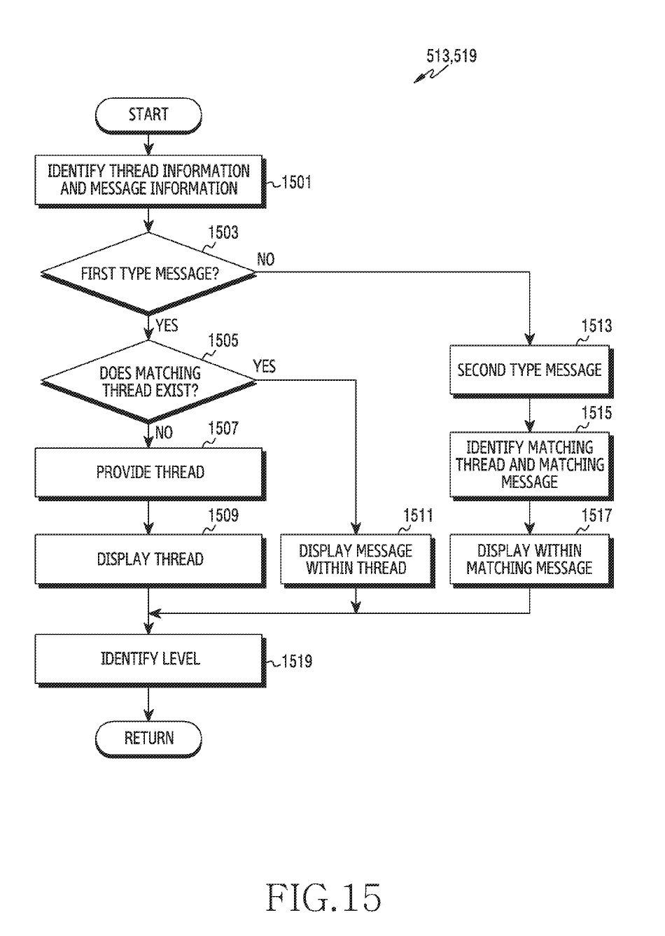

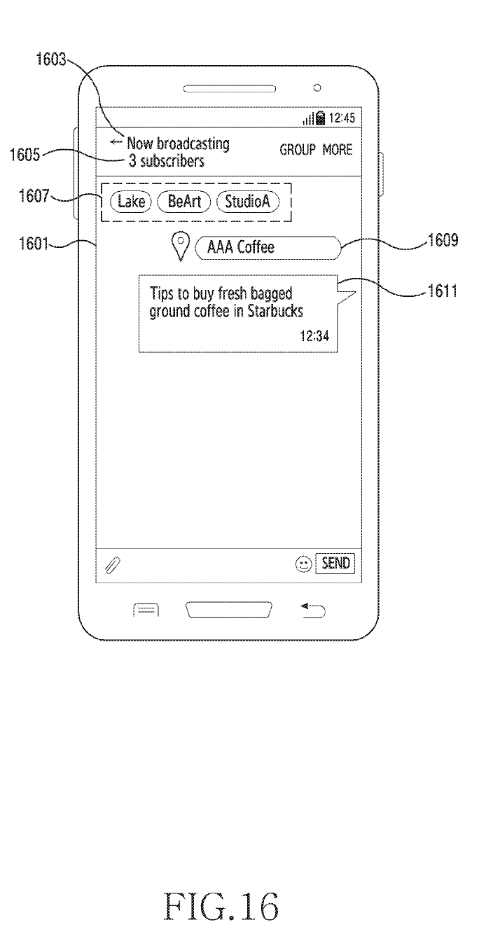

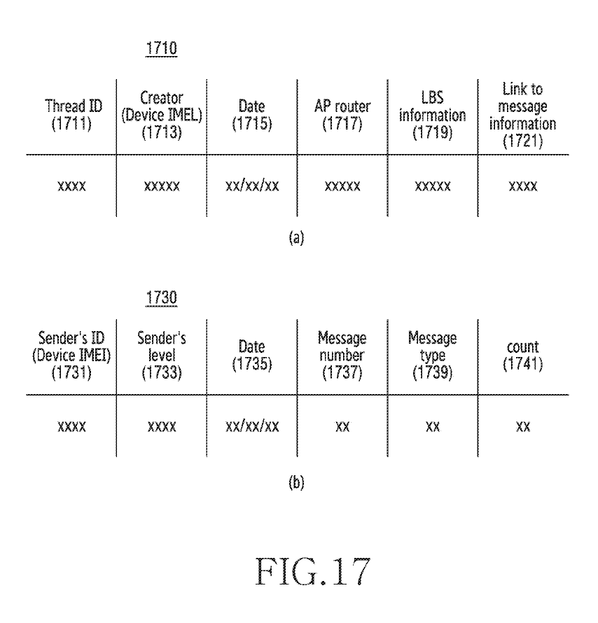

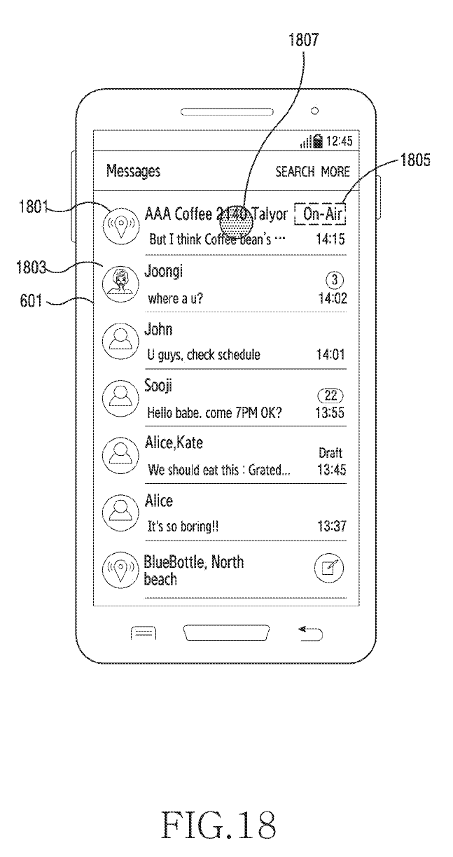

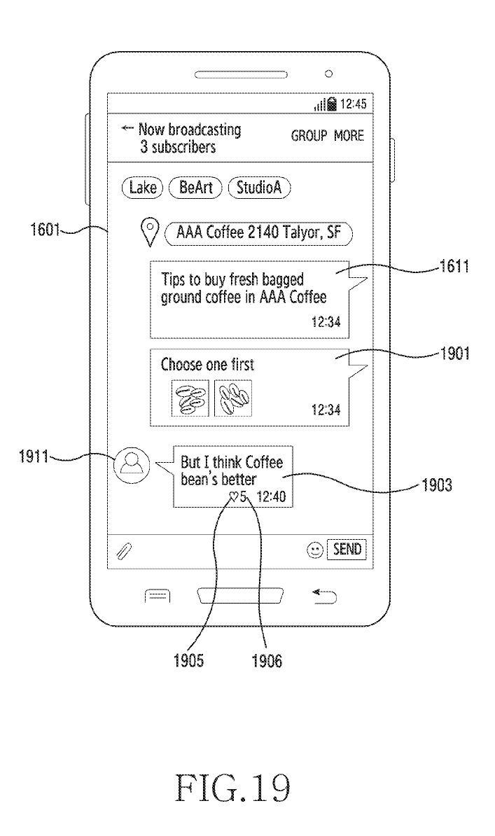

FIG. 15 is a flowchart illustrating a procedure of performing the message display operation of FIG. 5. FIG. 16 is example diagrams of a screen of the electronic device according to various embodiments of the disclosure. FIG. 17 is a diagram illustrating thread information and message information according to various embodiments of the disclosure. FIG. 18 to FIG. 19 are example diagrams of a screen of the electronic device according to various embodiments of the disclosure.

As illustrated in FIG. 15, in operation 1501, the control unit 409 may identify thread information 1710 and message information 1730 which are included in a message. As illustrated In FIG. 16, a thread 1601 may be a screen of collecting a transmitted or received message 1611 to one place. The thread 1601 may be distinguished by relay device 103 performing broadcasting or external device 105 taking part in the broadcasting. For example, the thread 1601 may be distinguished according to the relay device 103 that is connected to perform the broadcasting. Or, the thread 1601 may be distinguished according to a participation construction of the external devices 105 that connect to the same relay device 103 and participate in the broadcasting.

The thread 1601 may include a broadcasting title 1603, a broadcasting participant count 1605, an identification name 1607 of a broadcasting participant/a participant electronic device 100 or external device 105, a name of the specified region 107 where the broadcasting is performed/a brand related with the specified region 107/a shop name 1609 and message 1611 related with the specified region 107, and the like.

As illustrated in FIG. 17(a), the thread information 1710 may include a thread ID 1711 distinguishing each thread, a thread creator (Device IMEI) 1713, a thread creation date 1715, an AP router 1717 location based service (LBS) information 1719, connection information (link to message information) 1721 of the message information 1730, or the like. Meantime, as illustrated in FIG. 17(b), the message information 1730 may include a message sender (sender's ID (Device IMEI)) 1731, a sender's level 1733, a message sending date 1735, a message number 1737, a message type 1739, a second type message reception count 1741, or the like.

In operation 1503, the control unit 409 may identify whether the message intended to be sent is a first type message, based on the thread information 1710 and message information 1730 of the message identified in operation 1501. For example, the control unit 409 may identify whether the message intended to be sent is the first type message through the message type 1739 among the message information 1730. The first type message may be a message including at least any one of a text, a photo, an audio or a video.

In response to it being identified that the message intended to be sent is the first type message, in operation 1505, the control unit 409 may identify whether a matching thread exists. The matching thread may be a thread including a thread ID 1711 which is matched with the thread ID 1711 of the message intended to be sent. In operation 1505, the control unit 409 may identify whether the matching thread exists, based on the thread information 1710 and message information 1730 of the message identified in operation 1501. For example, the control unit 409 may identify whether a thread ID 1711 stored in the storage unit 403 and the thread ID 1711 of the message intended to be sent are matched with each other.

In response to it being identified that the matching thread does not exist, in operation 1507, the control unit 409 may provide the thread 1601. For example, in response to the thread ID 1711 of the storage unit 403 matched with the thread ID 1711 of the message intended to be sent not existing, the control unit 409 may provide a new thread 1601. In case where the electronic device 100 sends a message in order to perform broadcasting for the first time in the specified region 107, it may correspond to this.

In operation 1509, the control unit 409 may display the provided thread 1601 on the display unit 407. In response to providing and displaying the thread 1601, as illustrated in FIG. 16, the control unit 409 may display the message 1611 written in operation 503 within the thread 1601. Meantime, as illustrated in FIG. 18, the control unit 409 may display a thread item 1801 provided in the message application screen 601, together with another message item 1803 as well. Also, the control unit 409 may display, in the thread item 1801, an ‘On-Air’ icon 1805 of displaying that it is performing broadcasting as well. In response to receiving an input 1807 of selecting this thread item 1801, as illustrated in FIG. 19, the control unit 409 may display the thread 1601 corresponding to the input 1807 of selecting the thread item 1801.

Meantime, in response to identifying that the matching thread exists in operation 1205, in operation 1211, the control unit 409 may display the message within the matching thread. For example, in response to the thread ID 1711 of the message intended to be sent and the thread ID 1711 stored in the storage unit 403 being matched with each other, the control unit 409 may display the message in the thread 1601 having the matched thread ID 1711. For example, as illustrated in FIG. 16, in response to sending the message 1601, the control unit 409 may display the message 1611 within the matched thread 1601.

On the other hand, in response to it being identified that the message intended to be sent is not the first type message in operation 1503, the control unit 409 may, in operation 1513, identify that the message intended to be sent is a second type message. For example, the control unit 409 may identify that the message intended to be sent is not the first type message through the message type 1739 among the message information 1730. The second type message may be a feedback message for selecting a preferred message. That is, the second type message may be a message including interest information about the first type message. For example, the second type message may be a message for, in response to there being a preferred message in course of execution of broadcasting, forwarding an intention of liking the corresponding message.

Next, in operation 1515, the control unit 409 may identify a matching thread and a matching message. The matching message may be a message including a matching number 1737 that is matched with the matching number 1737 of the message intended to be sent. For example, the control unit 409 may identify a thread ID 1711 that is matched with the thread ID 1711 in the thread information 1710 of the second type message. Also, the control unit 409 may identify a message number 1737 that is matched with the message number 1737 in the message information 1730 of the second type message. On the other hand, the message number 1737 of the second type message may be a message number 1737 of a target message indicated by the second type message.

Next, in operation 1517, the control unit 409 may display an icon reflecting the second type message within the matching message. That is, the control unit 409 may display the icon reflecting the second type message within the target message indicated by the second type message. For example, as illustrated in FIG. 19, the control unit 409 may display, by a heart shape icon 1905, the second type message within a matching message 1903. The control unit 409 may display the number of times of selection of the matching message 1903, in adjacent to the heart shape icon 1905. The control unit 409 may display the number 1906 of times in which the matching message 1903 receives the second type message, together. That is, the control unit 409 may display the number 1906 of times of receiving the second type message. Meantime, in response to receiving an input of selecting the matching message 1903, or receiving an input of selecting an identification icon 1911 for identifying a sender, the control unit 409 may send the second type message.

Next, in operation 1519, the control unit 409 may identify a broadcasting level of the electronic device 100. The broadcasting level may be an indicator of indicating a broadcasting experience of the electronic device 100 in the specified region 107. That is, the broadcasting level may indicate an experience value that the electronic device 100 performs broadcasting in connection with the relay device 103 defining the specified region 107. Through this, a reliability degree of a message received at broadcasting may be identified. For example, the broadcasting level may be specified considering the number of times of participating in broadcasting, the number of messages sent at broadcasting, the number of times of reception of the second type message from the external device 105, or the like. This broadcasting level may be identified whenever a message is sent or received. But, an embodiment is not limited to this, and the broadcasting level may be identified and refined according to a specific period of time as well. Also, the broadcasting level may be identified according to the type of broadcasting. For example, the electronic device 100 may have a mutually different level according to an AP connected at broadcasting. That is, the electronic device 100 may have a level by specified region 107 performing the broadcasting. This level information is stored in the storage unit 403 and, in response to later connected to a corresponding AP and again performing the broadcasting, the electronic device 100 may again identify a level, based on the previously stored level information.

Meantime, the control unit 409 may display the identified level. The control unit 409 may display the identified level within a message. Or, the control unit 409 may display within the identification icon 1911 for identifying a sender in the thread 1601 as well. Or, the control unit 409 may display the level only in response to a user input being identified as well.

In operation 1519, the control unit 409 may identify the level and return. Accordingly, the control unit 409 may send the written message in operation 515 of FIG. 5. The control unit 409 may identify a level of the electronic device 100, to send a message including the identified level information. The control unit 409 may send the message to the external device 105 connected to the same relay device 103. That is, the control unit 409 may send the message to the external device 105 which participates in the broadcasting within the specified region 107 through the relay device 103. Through this, the electronic device 100 may send the message to the plurality of external devices 105 whose identification data is not identified on a near field in the specified region 107. Accordingly, the control unit 409 may perform more free communication.

Meantime, in response to not sensing the message writing request in operation 501, the control unit 409 may, in operation 517, sense whether a message is received through the communication unit 401. The message received in operation 517 may be a message received in course of performing broadcasting. The message received in operation 517 may be a message received from the external device 105 in the specified region 107. That is, the message whose reception is sensed in operation 517 may be a message received through the corresponding relay device 103 in course of connecting with the relay device 103 defining the specified region 107. In response to the message reception not being sensed, the control unit 409 may return to operation 501 to sense a message writing request.

Next, in response to sensing the message reception through the communication unit 401, in operation 519, the control unit 409 may display a thread or message through the display unit 407. The message display operation may be the same or similar as earlier explained in FIG. 15.

That is, as illustrated in FIG. 15, in operation 1501, the control unit 409 may identify thread information 1710 and message information 1730 of the received message. Next, in operation 1503, the control unit 409 may identify whether the received message is a first type message. In response to it being identified that the received message is the first type message, in operation 1505, the control unit 409 may identify whether a matching thread exists. In operation 1505, the control unit 409 may identify whether the matching thread exists, based on the thread information 1710 and message information 1730 of the message identified in operation 1501. In response to it being identified that the matching thread does not exist, in operation 1507, the control unit 409 may provide a thread. That is, the control unit 409 may provide a new thread through the received message. In response to the electronic device 100 receiving a message for the first time after connecting with the relay device 103 in order to perform broadcasting in the specified region 107, it may correspond to this. In operation 1509, the control unit 409 may display the thread. The control unit 409 may display the received message within the thread.

Meantime, in response to identifying that the matching thread exists in operation 1505, the control unit 409 may, in operation 1511, display the received message within the matching thread. On the other hand, in response to it being identified that the received message is not the first type message in operation 1503, the control unit 409 may, in operation 1513, identify that the received message is a second type message. Next, in operation 1515, the control unit 409 may identify a matching thread and matching message of the second type message. Next, in operation 1517, the control unit 409 may display the second type message within the matching message. Meantime, in operation 1515, the control unit 409 may identify whether a sender is the electronic device 100 itself in the message information 1730 of the matching message. In response to the sender of the matching message being the electronic device 100 itself, the control unit 409 may adjust up the level, at the time of identifying the level in operation 1519. That is, in response to receiving the second type message from the external device 105 responsive to the message sent by the electronic device 100, it may be considered for the level identifying.

Meantime, referring again to FIG. 5, after operation 515 and operation 519, the control unit 409 may, in operation 521, identify ending or not. That is, the control unit 409 may identify the ending or non-ending of the broadcasting that is being executed. In response to it being identified to get out of the specified region 107 through the communication unit 401, the control unit 409 may identify to end the broadcasting. For example, in response to sensing that a connection with the relay device 103 has been ended through the communication unit 401, the control unit 409 may identify that the electronic device 100 gets out of the specified region 107. Or, the control unit 409 may identify a position of the electronic device 100 through the communication unit 401, and identify that the identified position gets out of the specified region 107 as well. Also, in response to receiving a user input of ending the broadcasting through the input unit 405, the control unit 409 may identify that it ends the broadcasting.

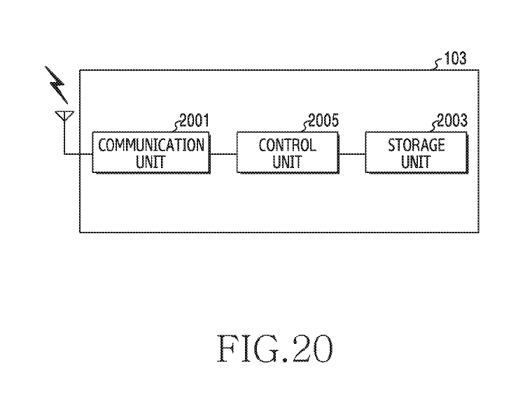

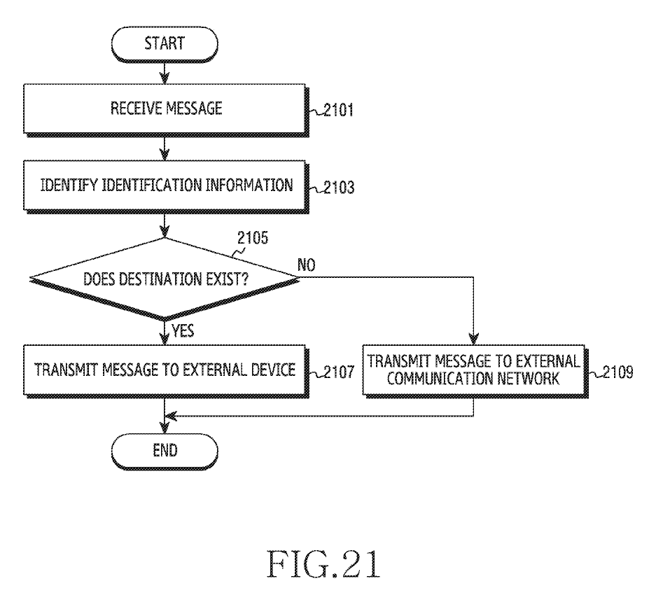

FIG. 20 is a block diagram of a relay device according to various embodiments of the disclosure. FIG. 21 is a flowchart illustrating a procedure of performing an operation method of the relay device according to the various embodiments of the disclosure.

As illustrated in FIG. 20, according to various embodiments of the disclosure, the relay device 103 may include a communication unit 2001, a storage unit 2003, and a control unit 2005.

The communication unit 2001 of the relay device 103 may transmit a signal frequently or periodically. The communication unit 2001 of the relay device 103 may transmit a signal only within the specified region 107. For example, the communication unit 2001 of the relay device 103 may perform a near field communication. The communication unit 2001 of the relay device 103 may transmit a signal only up to a specific distance. Or, the relay device 103 may transmit a signal which includes position information defining the specified region 107. Through this, the relay device 103 may define the specified region 107. By transmitting the signal, the relay device 103 may identify whether the electronic device 100 located in the specified region 107 requests for broadcasting. The communication unit 2001 may receive identification data from the electronic device 100 or external device 107 performing a connection with the relay device 103 for the sake of broadcasting.

Also, the communication unit 2001 of the relay device 103 may receive a message from the electronic device 100. That is, the communication unit 2001 of the relay device 103 may receive a message from the electronic device 100 intending to perform broadcasting in the specified region 107. The communication unit 2001 may send a message that the electronic device 100 intends to broadcast, in accordance with a request of the electronic device 100.

The storage unit 2003 of the relay device 103 may store a program for transmitting and/or receiving a signal. Also, the storage unit 2003 of the relay device 103 may store identification information for identifying whether a received message is a message for broadcasting. Also, the storage unit 2003 may store identification data of the electronic device 100 and external device 105 connected with the relay device 103. In response to there being a message sending request from the electronic device 100 or the external device 105, the relay device 103 may send a message to the electronic device 100 or external device 105 connected with the relay device 103 through the stored identification data.

The control unit 2005 may control a general operation of the relay device 103. As illustrated in FIG. 21, in operation 2101, the control unit 2005 may receive a message from the electronic device 100. Next, in operation 2103, the control unit 2005 may identify identification information of the received message.

Next, in operation 2105, the control unit 2005 may identify whether a destination exists in the message. That is, the control unit 2005 may identify whether the received message is a message for broadcasting. In response to identifying that the received message does not include the destination, in operation 2105, the control unit 2005 may identify that the received message is the message for broadcasting. Accordingly, in operation 2107, the control unit 2005 may send the message to the external devices 105 located within the specified region 107. That is, in operation 2107, the control unit 2005 may send the message to the external devices 105 connected with the relay device 103 within the specified region 107. On the other hand, in response to identifying that the destination exists in the received message, in operation 2109, the control unit 2005 may send the message to an external communication network. That is, in response to the destination existing in the received message, the control unit 2005 may identify that it is not the message for broadcasting, and may enable to send the message to the corresponding destination.

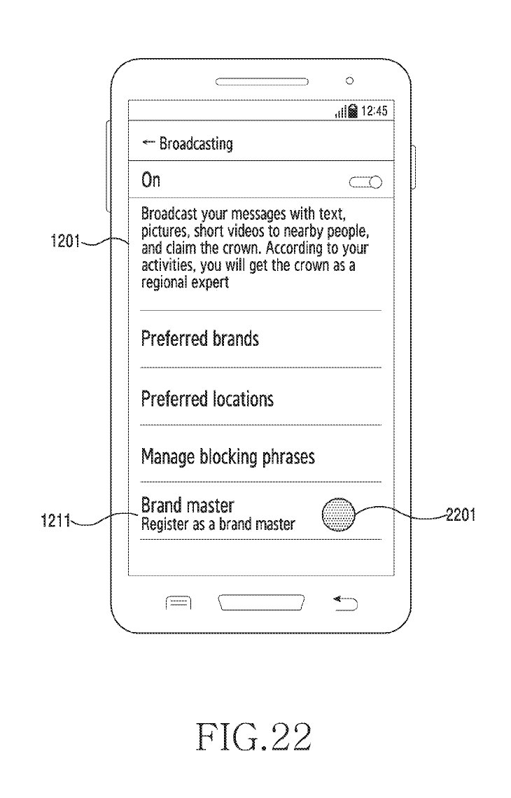

FIG. 22 to FIG. 61 are example diagrams of a screen of an electronic device according to various embodiments.

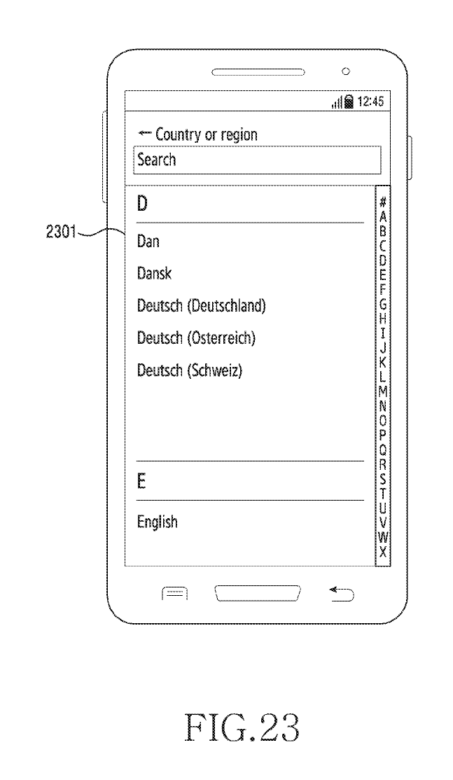

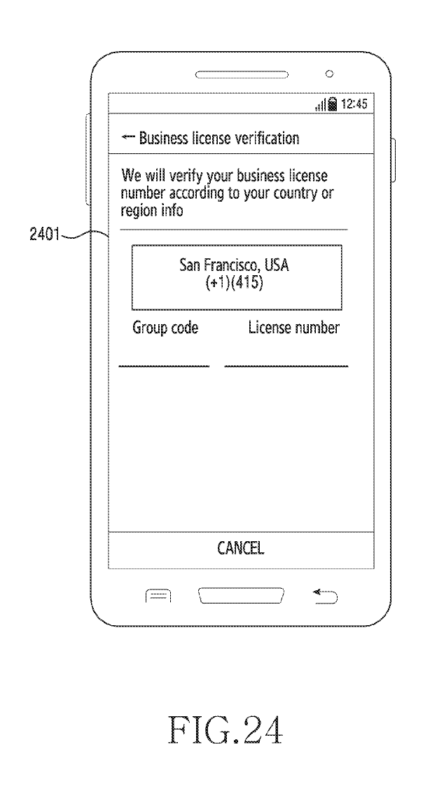

The electronic device 100 may perform broadcasting as a master of a specified brand or specified shop. The electronic device 100 may transmit a variety of information (for example, corresponding brand advertisement, event, coupon, etc.) to the external device 105 of a client who visits a specified shop. On the other hand, as illustrated in FIG. 22, the control unit 409 may sense an input 2201 of selecting the ‘Brand master’ function 1211 on the setting screen 1201 displaying various setting functions. As illustrated in FIG. 23, the control unit 409 may display a search screen 2301 capable of searching a specified area in which it will perform the broadcasting as the master. The control unit 409 may receive a user input, to search a specified brand or specified shop of a specified area. Next, as illustrated in FIG. 24, the control unit 409 may display a license verification screen 2401 capable of verifying a business license. The control unit 409 may receive a user input, to verify a business license of a specified brand or specified shop. For example, the control unit 409 may verify the license by receiving a country or regional code, or receiving a license number input.

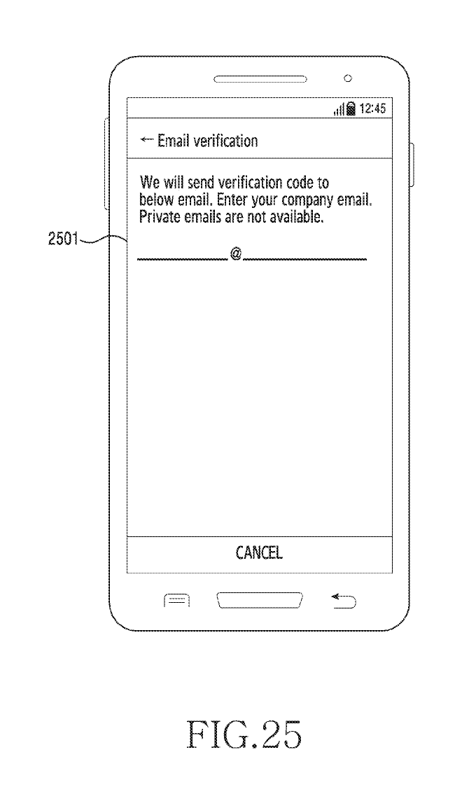

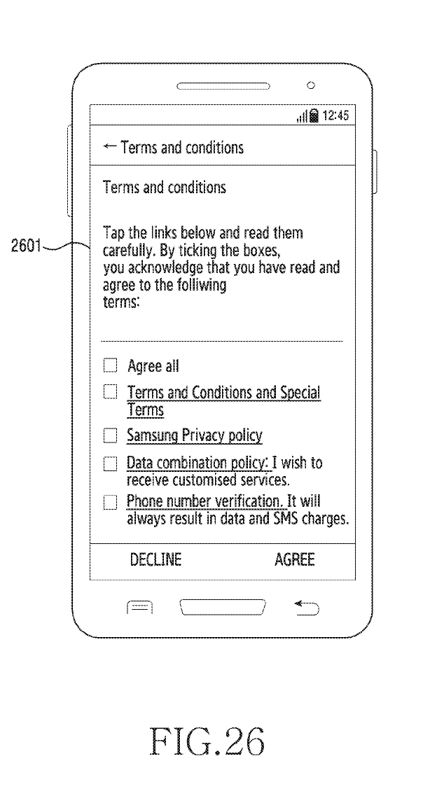

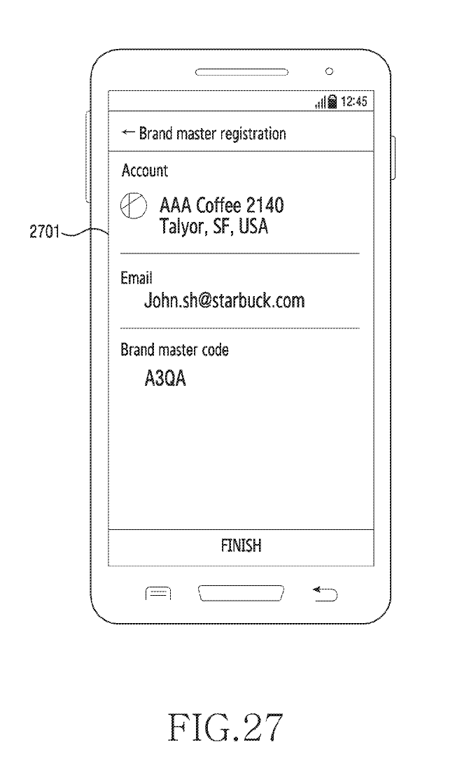

Next, as illustrated in FIG. 25, the control unit 409 may display a mail verification screen 2501 of requesting e-mail verification. The control unit 409 may receive a user input, to transmit a verification code by an inputted e-mail. Next, as illustrated in FIG. 26, the control unit 409 may display a condition screen 2601 of asking for consent to a condition for performing broadcasting as a master. The control unit 409 may receive a user input of agreeing to the condition for performing the broadcasting. Next, as illustrated in FIG. 27, the control unit 409 may display a completion screen 2701 of finishing registration as a brand master. The control unit 409 may grant a brand master code.

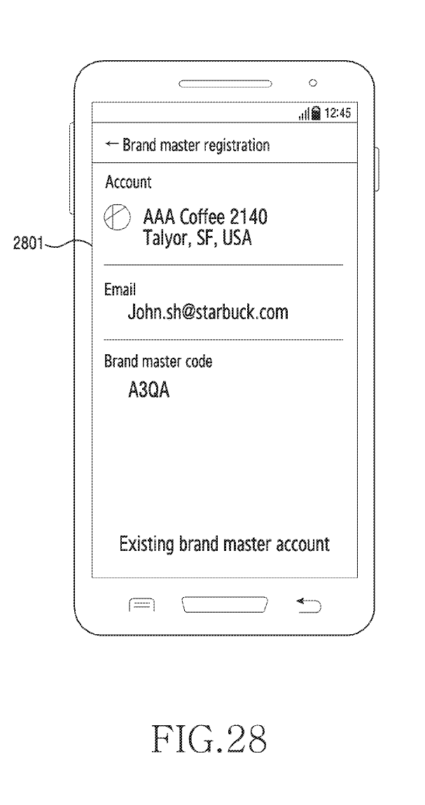

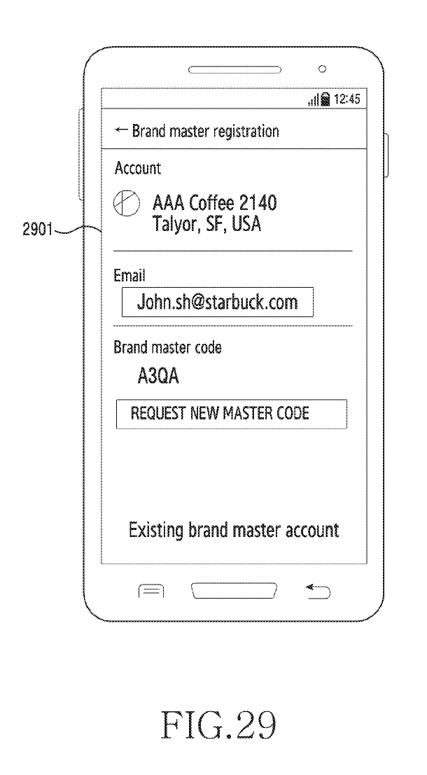

Meantime, in response to the electronic device 100 having been previously registered as a master of a specified brand or specified shop, in response to sensing the input 2201 of selecting the ‘Brand master’ function 911 in FIG. 22, as illustrated in FIG. 28, the control unit 409 may display a registration information display screen 2801 of displaying pre-registered information. On the other hand, the control unit 409 may display an icon for editing on the registration information display screen 2801 of displaying the pre-registered information, together. In response to sensing a user input to this icon for editing, as illustrated in FIG. 29, the control unit 409 may display an editing screen 2901. The control unit 409 may change a registered brand or registered shop through a user input on the editing screen 2901, or change registered e-mail information, or be given a new brand master code.

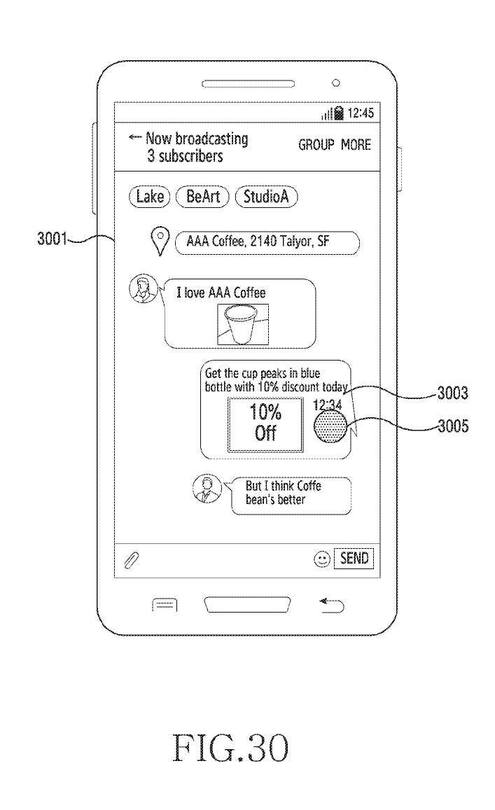

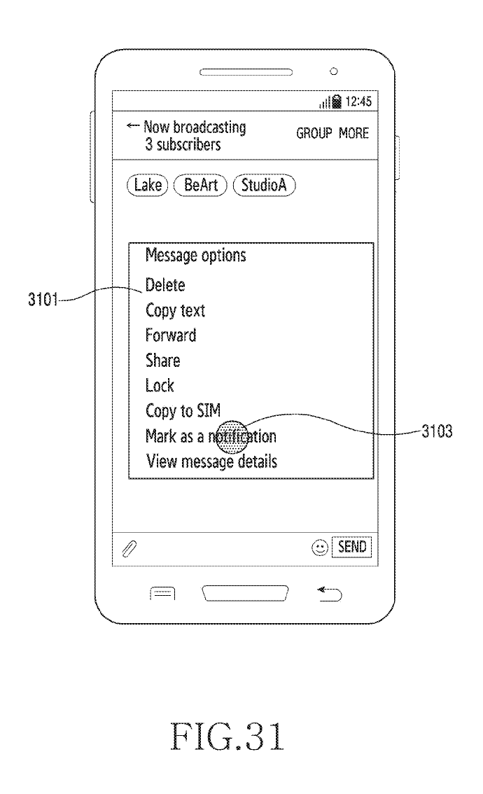

In response to the electronic device 100 participating in broadcasting as a master, the electronic device 100 may provide a variety of information to the external device 105 of a client who visits a specified shop. For example, as illustrated in FIG. 30, the electronic device 100 may perform broadcasting with the external device 105 of the client who visits the specified shop. At this time, the control unit 409 may display a thread 3001. The control unit 409 may send a message 3003 including a coupon to the external device 105 participating in the broadcasting. In response to receiving a user input 3005 to this message 3003, as illustrated in FIG. 31, the control unit 409 may display an option function list 3101. The option function may include delete, copy text, forward, share, lock, copy to SIM, mark as notification, view message details, or the like.

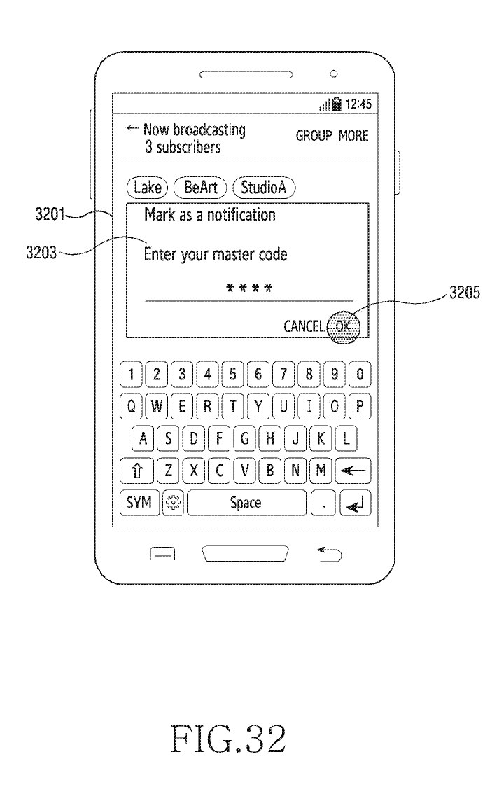

For example, in response to receiving a user input 3103 to a notification mark function, as illustrated in FIG. 32, the control unit 409 may display a screen 3201 for the notification mark function. The notification mark function may be, for example, a function of enabling to always display a selected message in a specified location within the thread 3001 in which broadcasting is being performed. That is, it is a function of fixing the selected message such that the selected message may be displayed without disappearing within the thread 3001 even if another message is continuously received within the thread 3001.

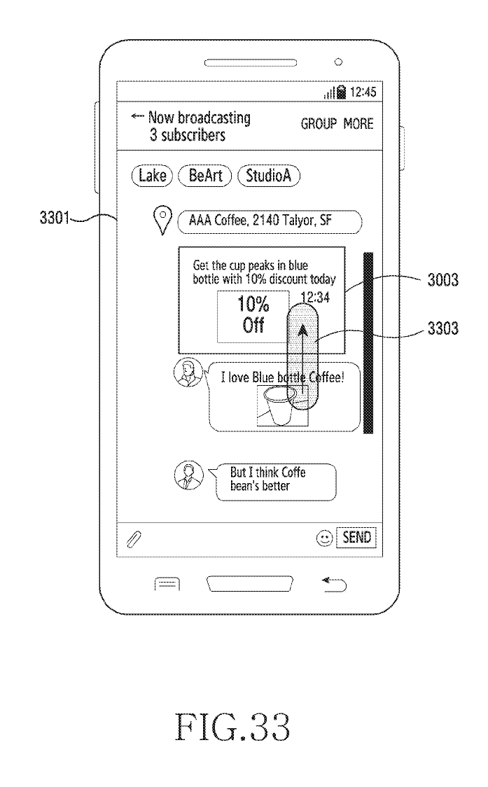

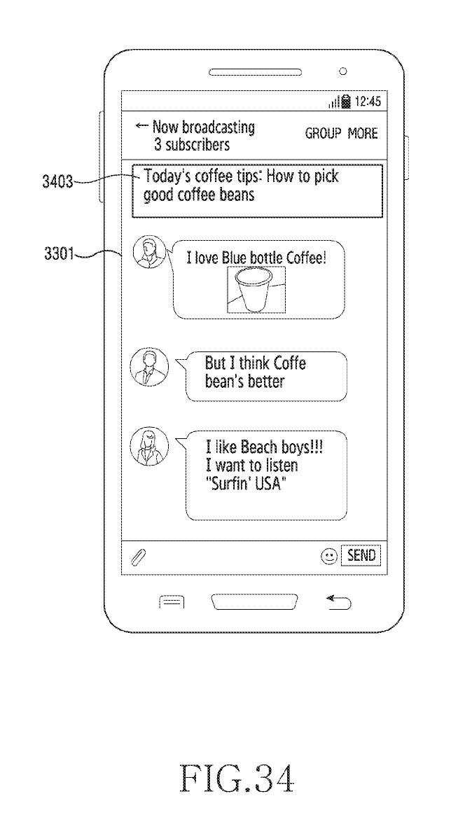

The control unit 409 may request for a master code input on the screen 3201 for the notification mark function. The control unit 409 may display a window 3203 for inputting a master code, and may receive the master code through a user input to the corresponding window 3203. Also, the control unit 409 may display a completion icon on the screen 3201 for the notification mark function. In response to sensing a user input 3205 on the completion icon, as illustrated in FIG. 33, the control unit 409 may fixedly display the selected message 3003 at an upper end of a thread 3301. For example, the whole substance of the message 3003 selected to be notification marked may be displayed at the upper end of the thread 3301. In response to the user input 3303 being received on the message 3003 selected to be notification marked, as illustrated in FIG. 34, the control unit 409 may display a partial message 3403 displaying only a part of the selected message at the upper end of the thread 3301.

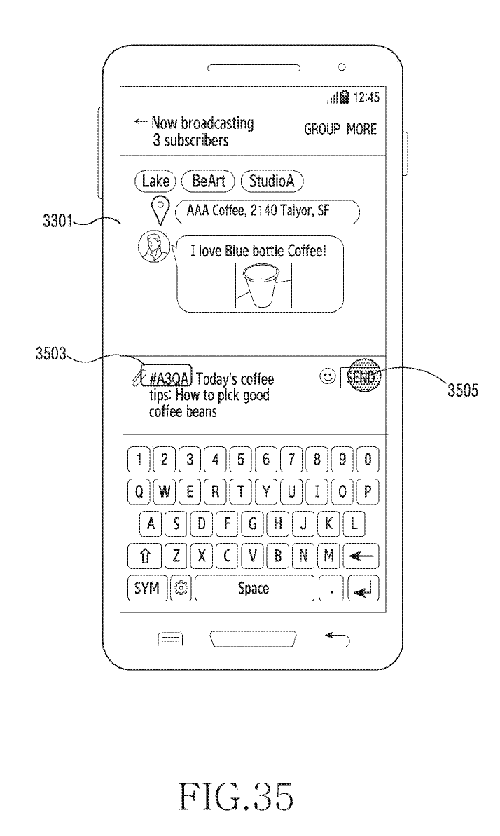

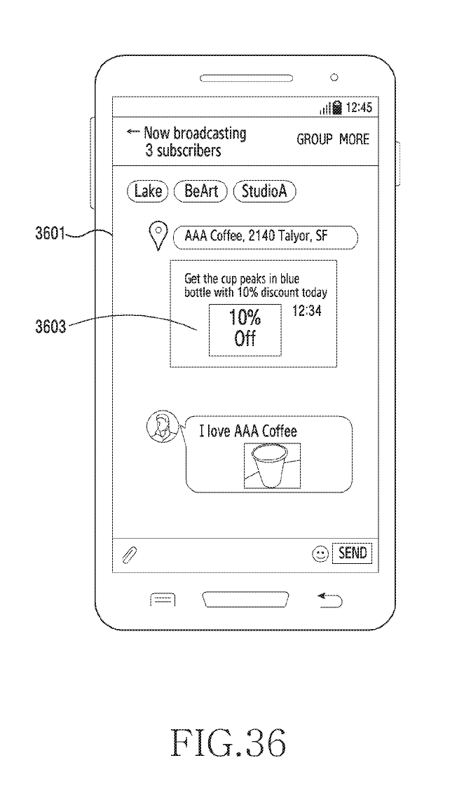

Meantime, the control unit 409 may control the notification mark function even without receiving an input in the option function list 3101. For example, as illustrated in FIG. 35, in response to receiving an input 3505 of sending a message that is written together with a tag (#) and master code 3503 within the thread 3301, the control unit 409 may grant the notification mark function to the corresponding message. Through this, as illustrated in FIG. 36, the control unit 409 may fixedly display a message 3603 that is written together with the tag and master code 3503, at an upper end of a thread 3601.

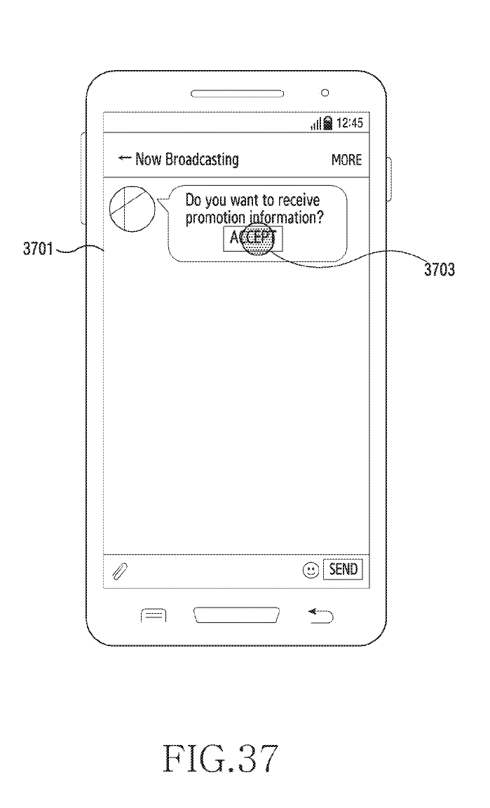

Meantime, in response to the electronic device 100 participating in broadcasting as a client who visits a specified shop, the electronic device 100 may receive a variety of information from a master. For example, as illustrated in FIG. 37, the control unit 409 may receive a message from the external device 105 being the master, and provide and display a thread 3701.

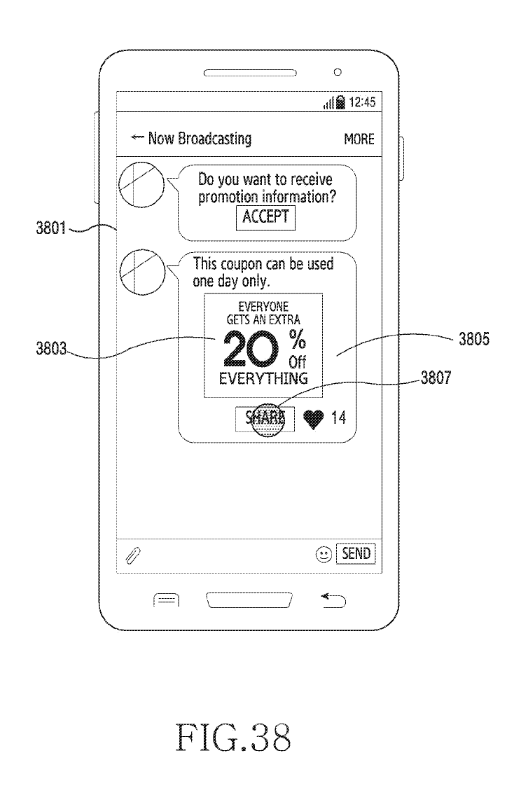

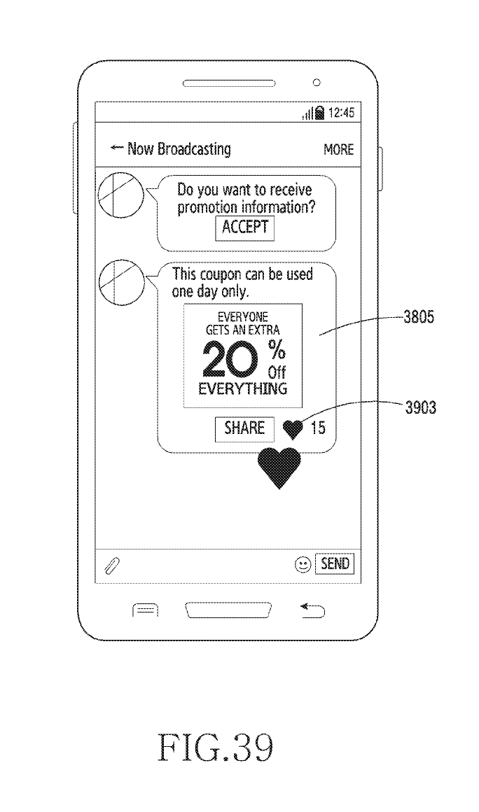

Meantime, the control unit 409 may receive a message including a promotion coupon, and may receive a user input 3703 on this message. In response to the user input 3703 being received on the message, as illustrated in FIG. 38, the control unit 409 may display a message 3805 including a promotion coupon 3803 within a thread 3801. In response to receiving a user input 3807 on the message 3805 including the promotion coupon 3803, the control unit 409 may send a second type message to the external device 105 having sent the corresponding message 3805. The control unit 409 may send the second type message and, as illustrated in FIG. 39, may display, by a heart shape icon 3903, the second type message selecting the corresponding message 3805. The control unit 409 may display the number of times of receiving the second type message, in the corresponding message 3805, together.

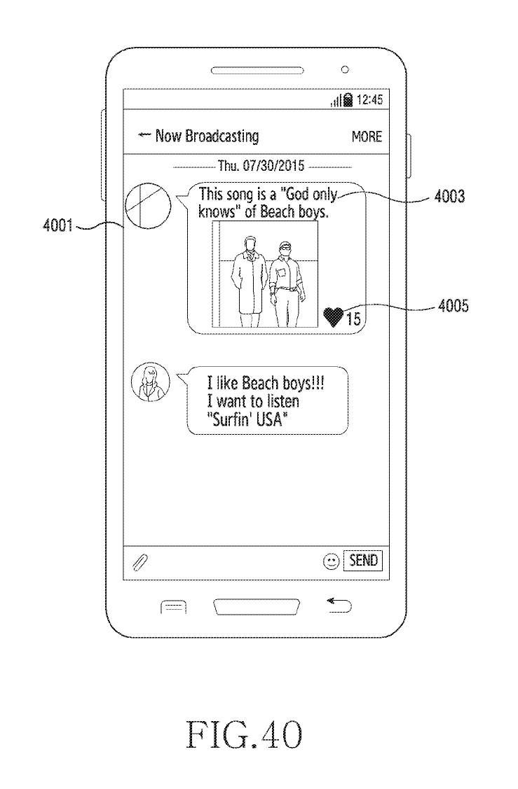

Meantime, in response to the electronic device 100 participating in broadcasting as a client who visits a specified shop, the electronic device 100 may receive a variety of information from a master. For example, as illustrated in FIG. 40, the control unit 409 may receive a message 4003 from the external device 105 being the master, and provide and display a thread 4001.

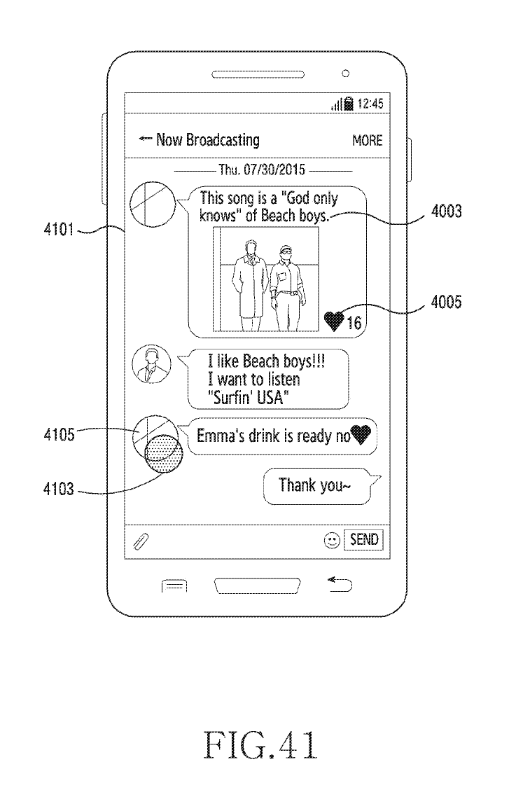

Meantime, the control unit 409 may receive the message 4003 including information about music that is being reproduced in the specified shop. The control unit 409 may display a second type message 4005 for the corresponding message 4003, together. The control unit 409 may receive a message from various external devices 105 which are taking part in broadcasting. As illustrated in FIG. 41, the control unit 409 may display a received message within a thread 4101. The control unit 409 may receive a user input 4103 on an identification icon 4105 for identifying a message sender. In response to receiving the user input 4103 on the identification icon 4105 for identifying the sender, the control unit 409 may send a second type message to the external device 105 corresponding to the corresponding sender.

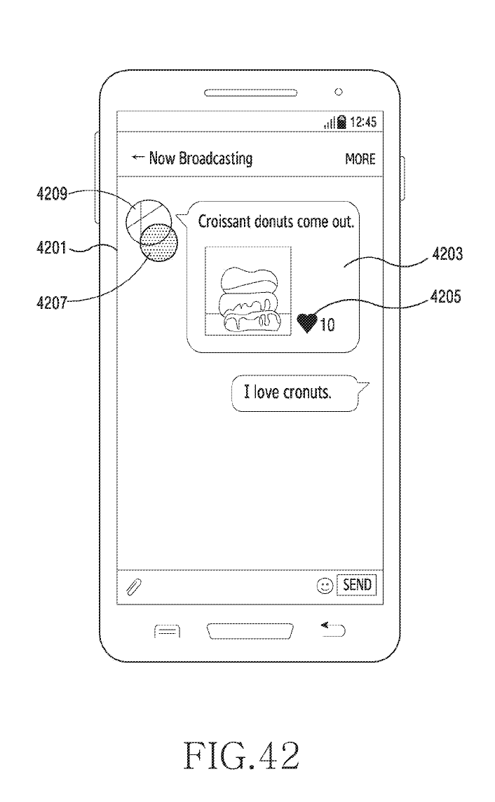

Meantime, in response to the electronic device 100 participating in broadcasting as a client who visits a specified shop, the electronic device 100 may receive a variety of information from a master. For example, as illustrated in FIG. 42, the control unit 409 may receive a message 4203 from the external device 105 being the master, and provide and display a thread 4201.

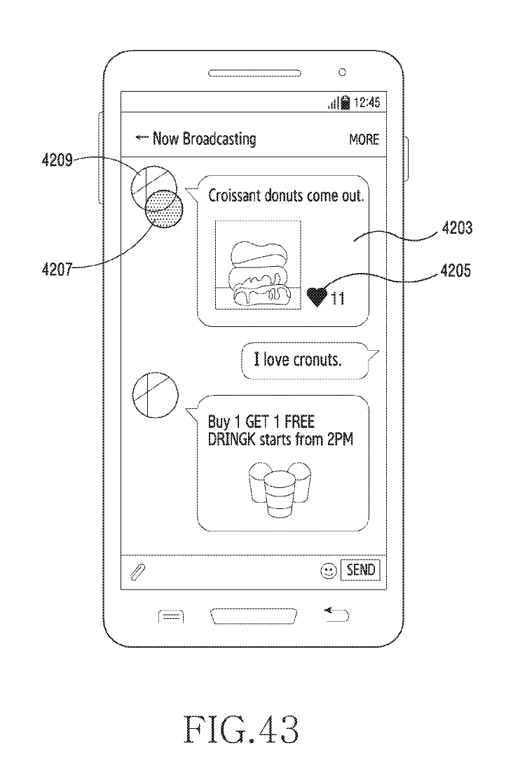

Meantime, the control unit 409 may receive the message 4203 including information related with a specified shop. For example, in response to the specified shop being a dessert store, the control unit 409 may receive the message 4203 including information that a dessert has been completed. The control unit 409 may display a second type message 4205 for the corresponding message 4203, together. The control unit 409 may receive a user input 4207 on an identification icon 4209 for identifying a message sender. In response to receiving the user input 4207 on the identification icon 4209 for identifying the sender, the control unit 409 may send the second type message to the external device 105 corresponding to the corresponding sender. As illustrated in FIG. 43, the control unit 409 may display the number of times of receiving the second type message 4205 for the corresponding message 4203, together.

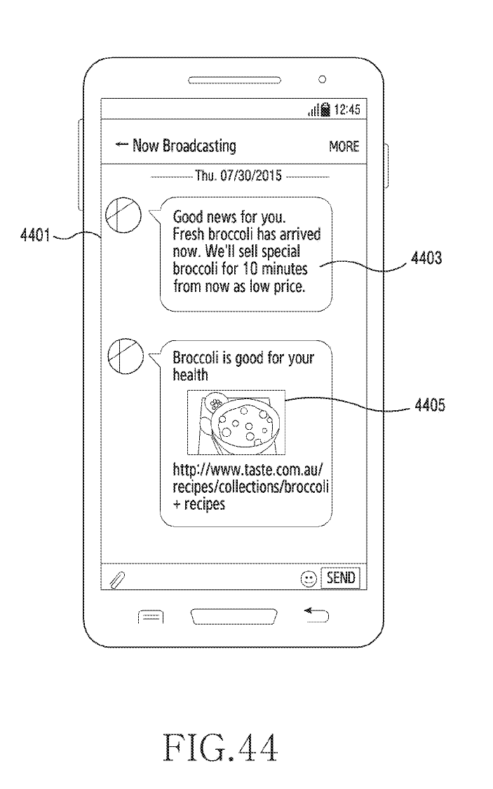

Meantime, in response to the electronic device 100 participating in broadcasting as a client who visits a specified shop, the electronic device 100 may receive a variety of information from a master. For example, as illustrated in FIG. 44, the control unit 409 may receive a message 4403 from the external device 105 being the master, and provide and display a thread 4401.

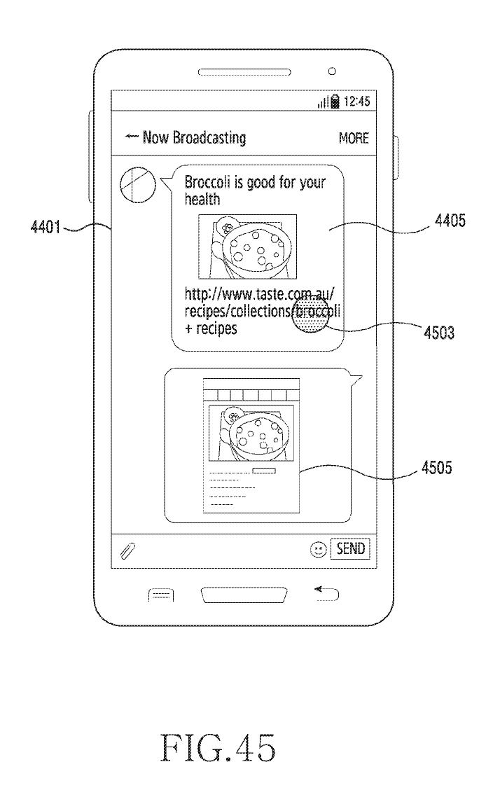

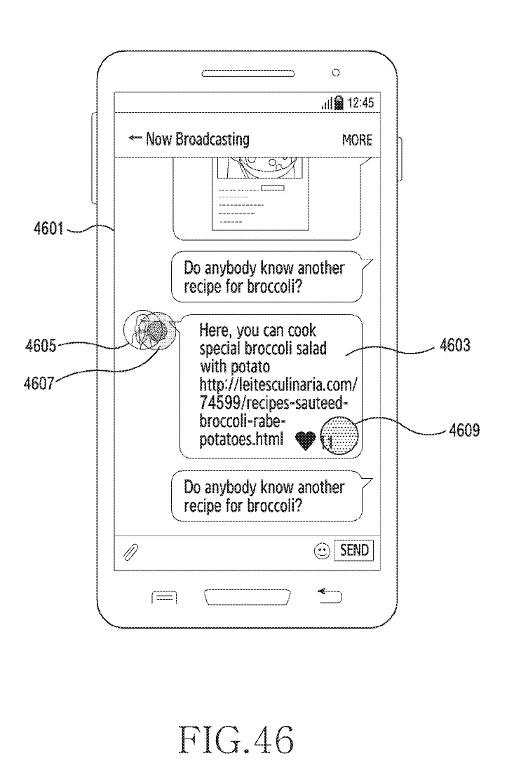

Meantime, the control unit 409 may receive the message 4403 including information related with a specified shop. For example, in response to the specified shop being a market, the control unit 409 may receive the message 4403 including sale information, etc. of the corresponding market. Or, the control unit 409 may receive a message 4405 including information on an item that is being sold in the corresponding market. Meantime, in response to including a link within the message 4405 and, as illustrated in FIG. 45, receiving a user input 4503 on the corresponding link, the control unit 409 may be connected to the corresponding link. As shown in FIG. 46, the control unit 409 may receive a user input 4607 on an identification icon 4605 for identifying a sender within a thread 4601. At this time, the control unit 409 may send a second type message to the external device 105 corresponding to the corresponding sender. Or, the control unit 409 may receive a user input 4609 within a message 4603. At this time, the control unit 409 may send the second type message to the external device 105 of a corresponding sender corresponding to the corresponding message.

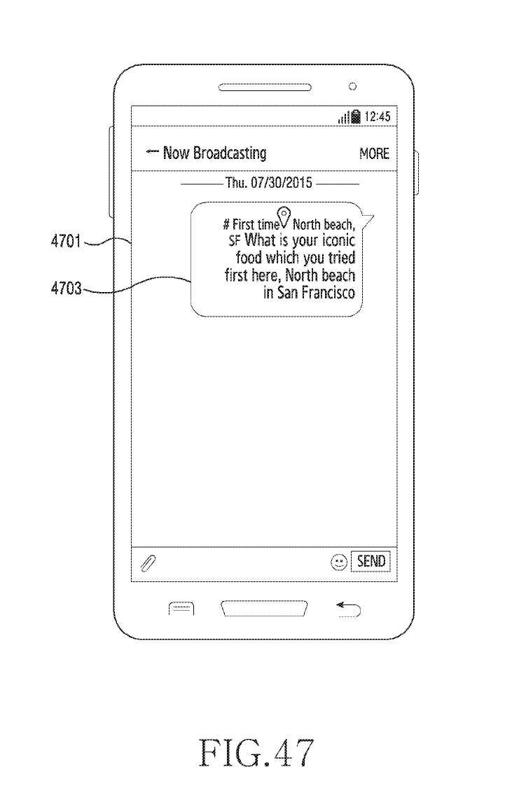

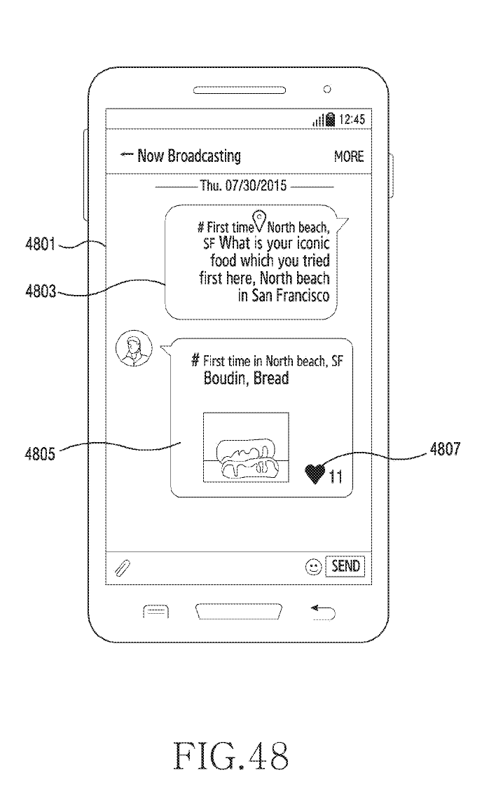

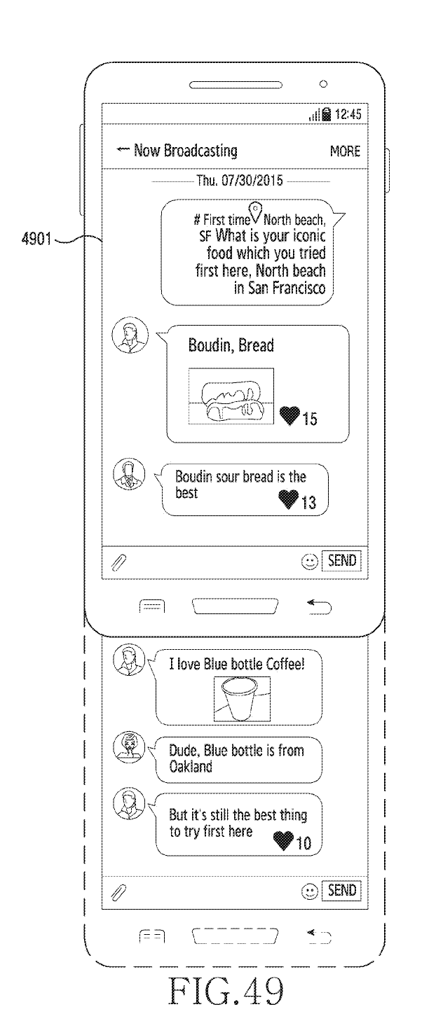

Meantime, in response to the electronic device 100 performing broadcasting with another external device 105 within the specified region 107, the electronic device 100 may receive a variety of information from the peripheral external device 105. For example, as shown in FIG. 47, in response to intending to start broadcasting in the specified region 107, the control unit 409 may send a message 4703, and provide and display a thread 4701. The control unit 409 may send the message 4703 of requesting for information sharing related with a specified area. As shown in FIG. 48, the control unit 409 may receive a message 4805 from the external device 105 taking part in broadcasting. The control unit 409 may display a second type message 4807 for the corresponding message 4805 within the message 4805, together. As shown in FIG. 49, the control unit 409 may receive messages from various external devices 105, and display the same within a thread 4901.

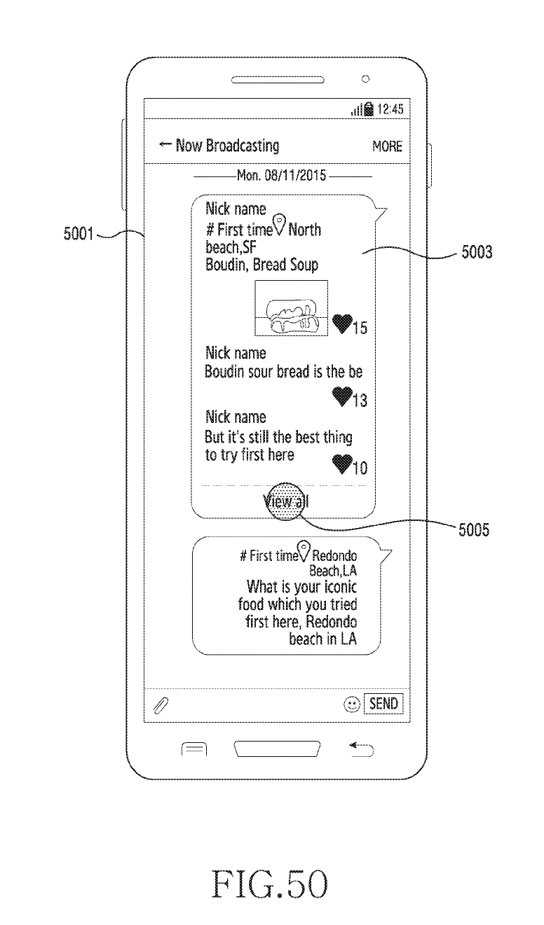

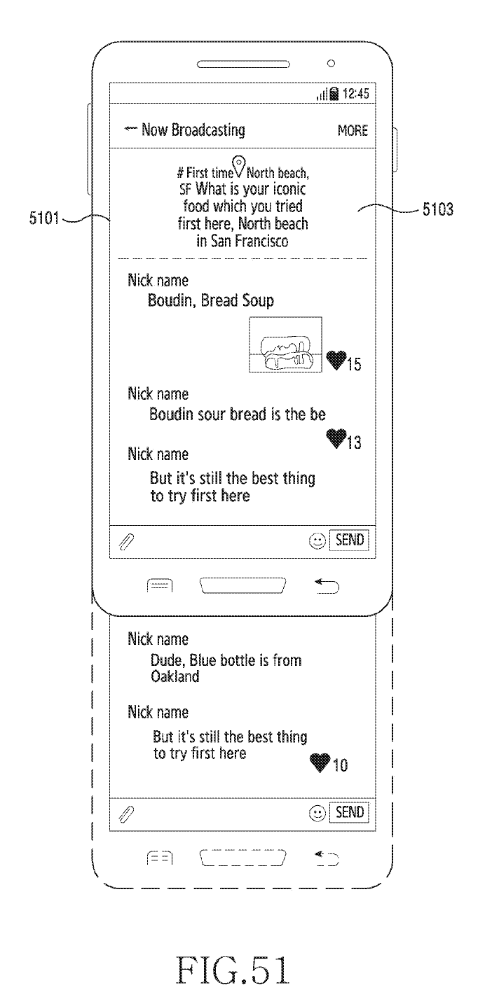

Meantime, as shown in FIG. 50, the control unit 409 may arrange messages in order of the high number of times of receiving a second type message within a thread 5001, and again transmit the arranged messages 5003 to the external device 105 as well. Through this, the control unit 409 may transmit processed information to the external device 105 as well. In response to receiving a user input 5005 to the arranged messages 5003, as illustrated in FIG. 51, the control unit 409 may display a screen 5103 of displaying all messages within a thread 5101 as well.

Through this, an electronic device 100 user may receive the sharing of a variety of information from unspecified individuals. Also, the electronic device 100 user may process the shared information, to again provide the same to the unspecified individuals.

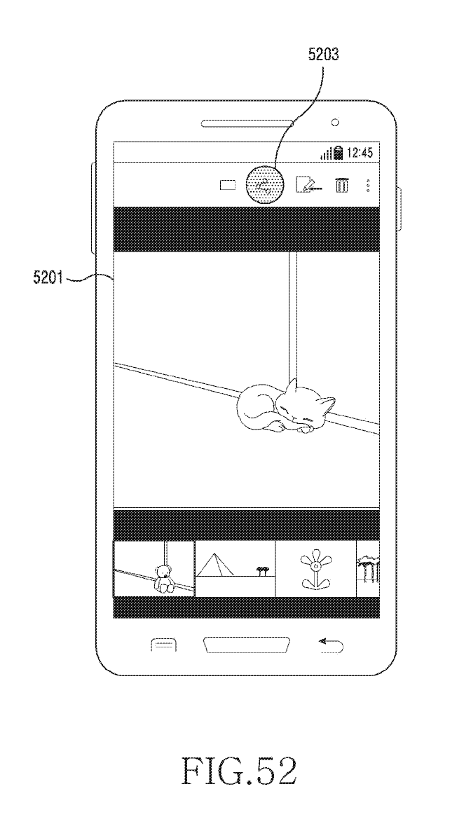

Meantime, the electronic device 100 may share various contents with the external device 105 located in the specified region 107, through broadcasting. For example, the control unit 409 may display a content display screen 5201 on the display unit 407. The control unit 409 may receive a user input 5203 for sharing contents on the content display screen 5201. For example, as illustrated in FIG. 52, the control unit 409 may display an icon for sharing contents on the content display screen 5201 together, and may receive the user input 5203 to the corresponding icon.

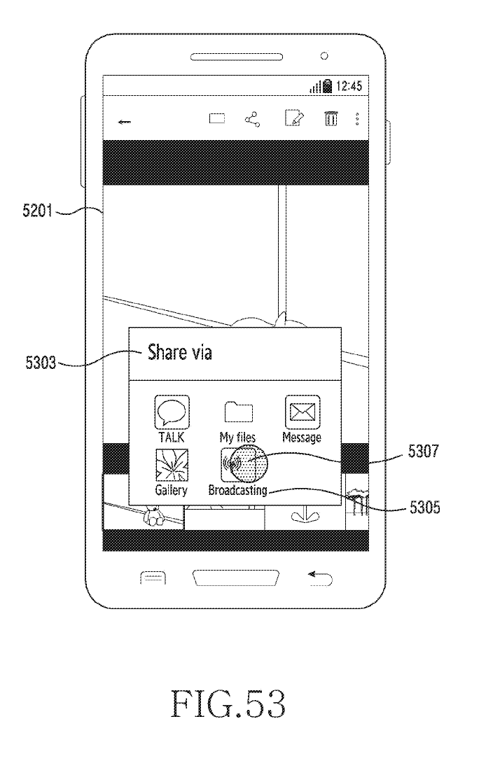

Next, as illustrated in FIG. 53, the control unit 409 may display a screen 5303 of displaying a sharing method on the content display screen 5201, together. The sharing method may include a method of sharing through broadcasting. Accordingly, the control unit 409 may display a broadcasting icon 5305 for sharing through broadcasting, on the screen 5303 of displaying the sharing method. The control unit 409 may sense a user input 5307 on the broadcasting icon 5305.

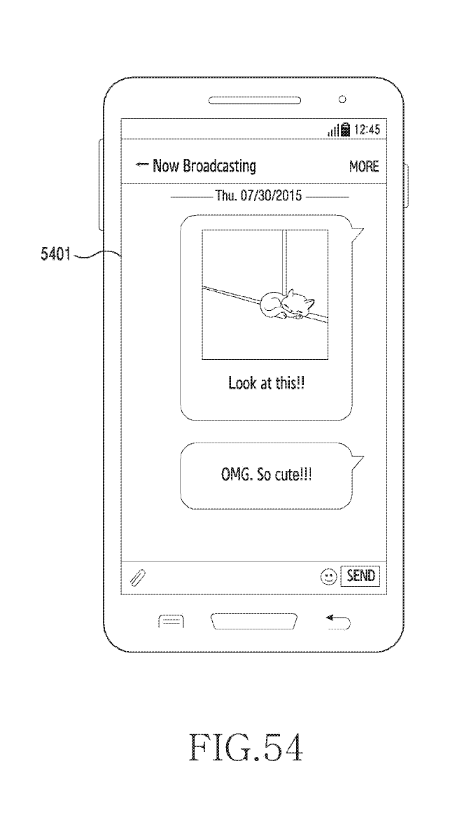

Next, in response to sensing the user input 5307 on the broadcasting icon 5305, as shown in FIG. 54, the control unit 409 may provide and display a thread 5401. Also, the control unit 409 may transmit a selected content to the external devices 105 located within the specified region 107.

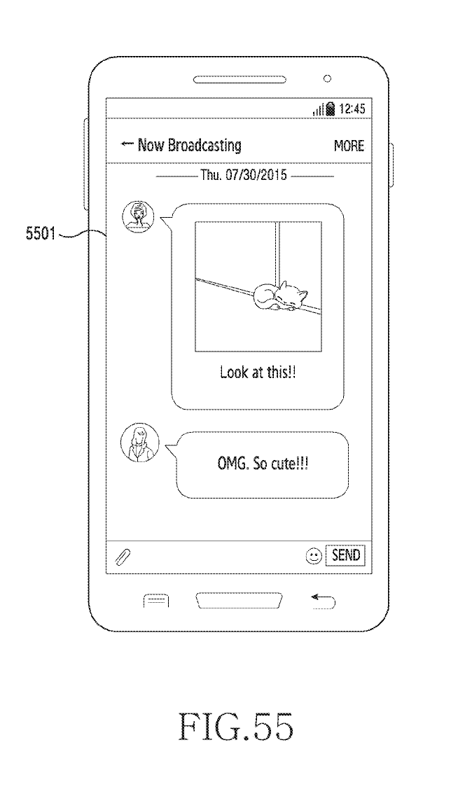

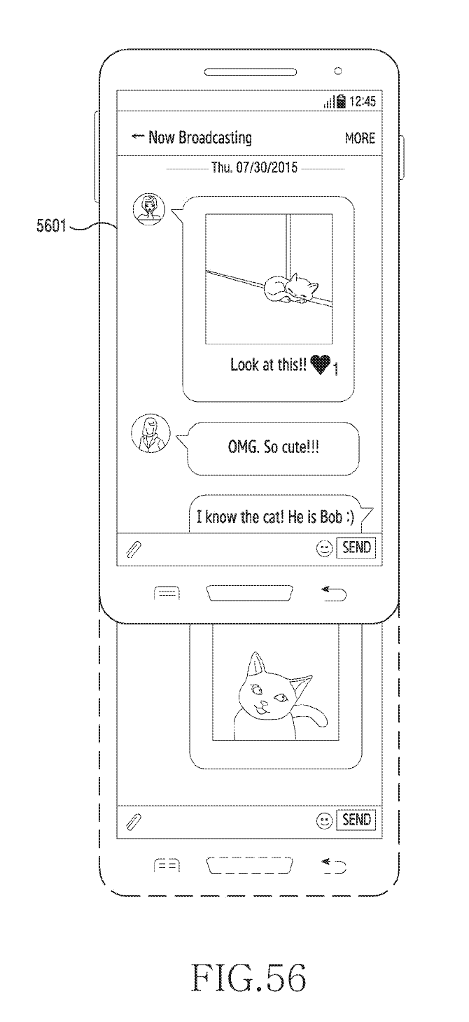

Meantime, as illustrated in FIG. 55, in response to the electronic device 100 receiving the sharing of contents through broadcasting, the control unit 409 may provide and display a thread 5501. As illustrated in FIG. 56, the control unit 409 may share another contents through the broadcasting.

The electronic device 100 user may receive the sharing of various contents from unspecified individuals. Also, the electronic device 100 user may again provide contents associated with the shared contents, to the unspecified individuals as well. That is, the contents may be freely shared between the electronic devices 100 located in the specified region 107.

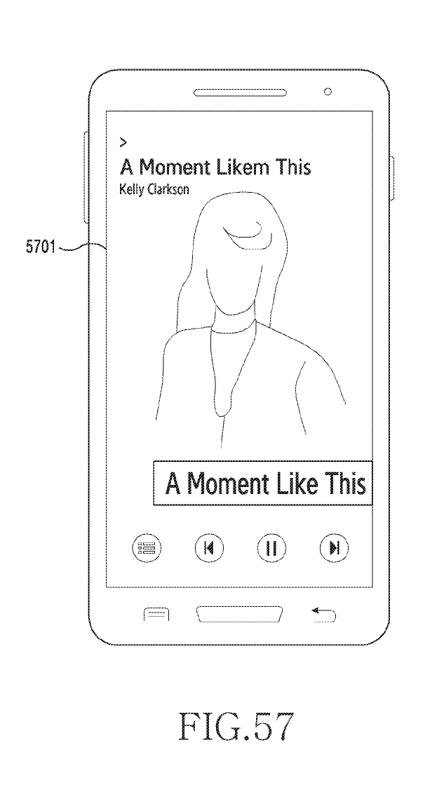

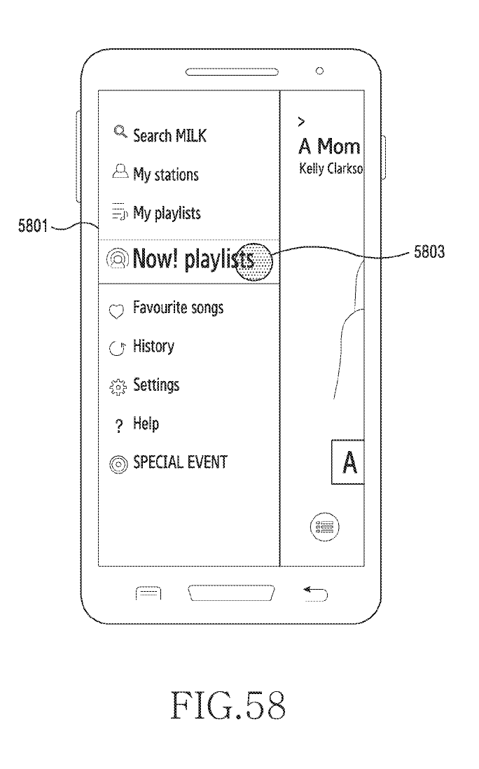

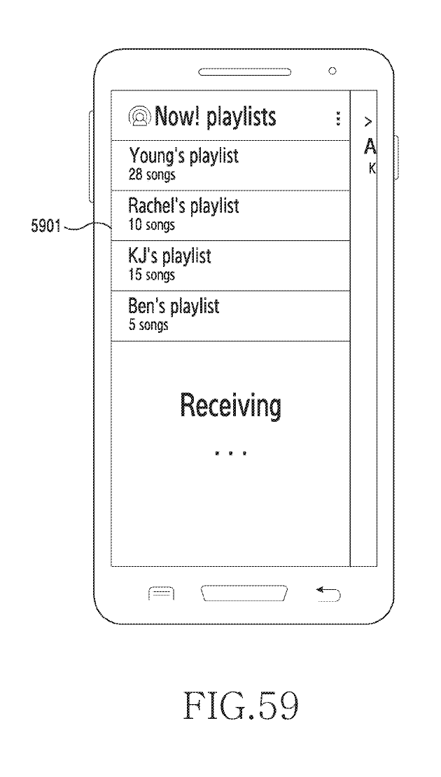

Meantime, in response to the electronic device 100 performing broadcasting with another external device 105 within the specified region 107, the electronic device 100 may receive a variety of information from the peripheral external device 105. For example, as shown in FIG. 57, in response to running a music application in the specified region 107, the control unit 409 may display a music application screen 5701. In response to sensing a user input on the music application screen 5701, as shown in FIG. 58, the control unit 409 may display a menu screen 5801. A function capable of sharing a playlist through broadcasting may be displayed on the menu screen 5801. In response to a user input 5803 for sharing a playlist through broadcasting being received, as shown in FIG. 59, the control unit 409 may receive a playlist from the external devices 105 located in the specified region 107. The control unit 409 may display a playlist screen 5901 of displaying playlists received from the external device 105. For example, the control unit 409 may display an ID of an electronic device having transmitted a playlist, and the number of the playlists, on the playlist screen 5901.

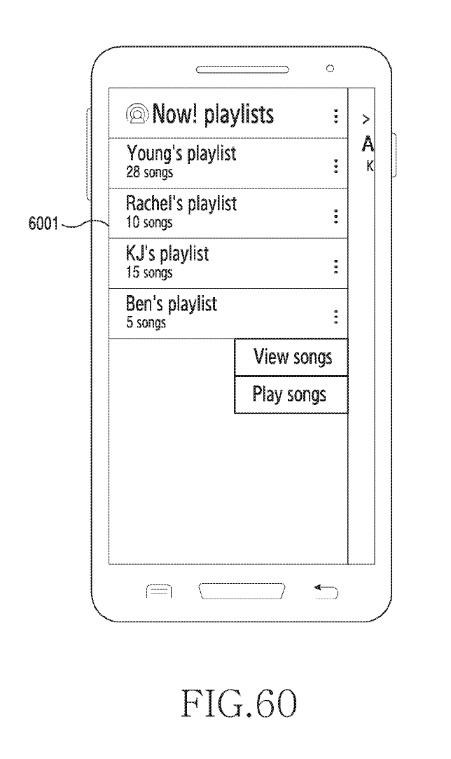

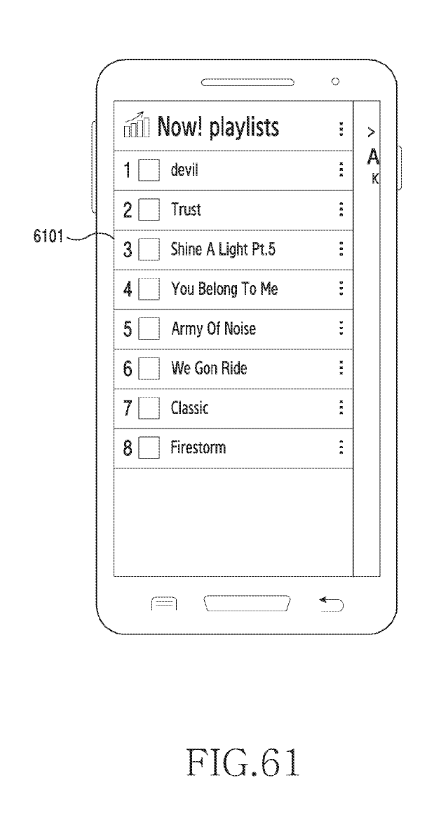

In response to sensing a user input on a playlist screen 6001, the control unit 409 may display various functions. For example, as illustrated in FIG. 60, the control unit 409 may display a function for displaying a detail item of a playlist transmitted by each external device 105, a function for reproducing the playlist, or the like, on the playlist screen 6001. In response to receiving a user input for performing a specified function on the playlist screen 6001, as illustrated in FIG. 61, the control unit 409 may display a detail screen 6101 of displaying a detail item of a playlist.

Through this, the electronic device 100 user may receive the sharing of a variety of information from unspecified individuals. Also, the electronic device 100 user may again provide contents associated with shared contents, to the unspecified individuals as well. That is, the contents may be freely shared between the electronic devices 100 located in the specified region 107.

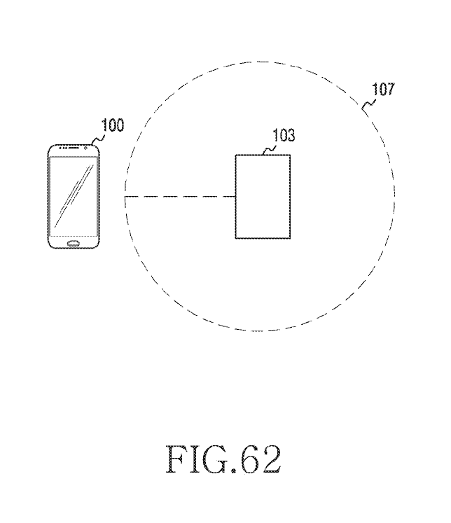

Meantime, as illustrated in FIG. 62, in response to getting out of the specified region 107, the electronic device 100 may terminate broadcasting. In response to sensing that a connection with the relay device 103 has been ended through the communication unit 401, the control unit 409 may identify that the electronic device 100 gets out of the specified region 107. Or, the control unit 409 may identify a position of the electronic device 100 through the communication unit 401, and identify that the identified position gets out of the specified region 107 as well. Also, in response to receiving a user input of ending the broadcasting through the input unit 405, the control unit 409 may identify to end the broadcasting.

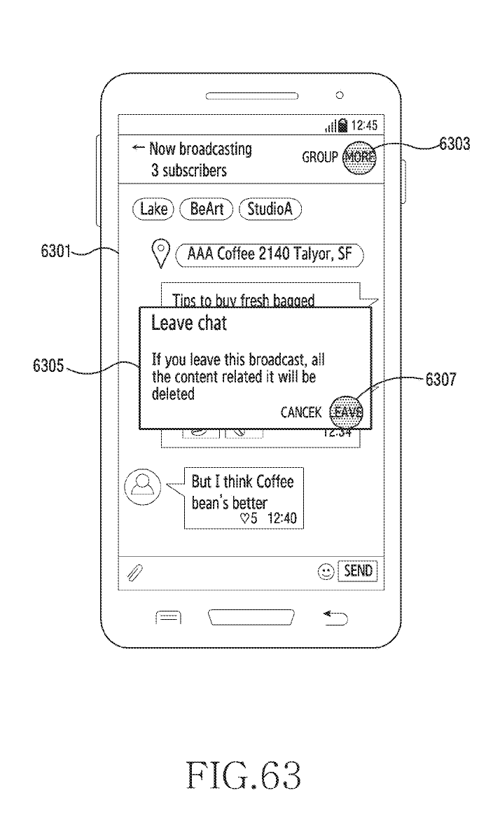

In response to identifying to end the broadcasting, as illustrated in FIG. 63, the control unit 409 may display an ending notification message 6305 within a thread 6301. In response to ending the broadcasting, the ending notification message 6305 may notify that all the contents within the thread 6301 are deleted.

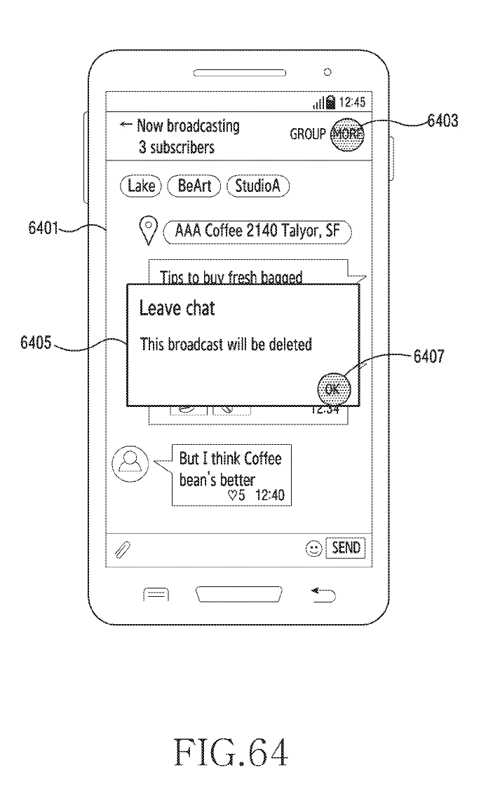

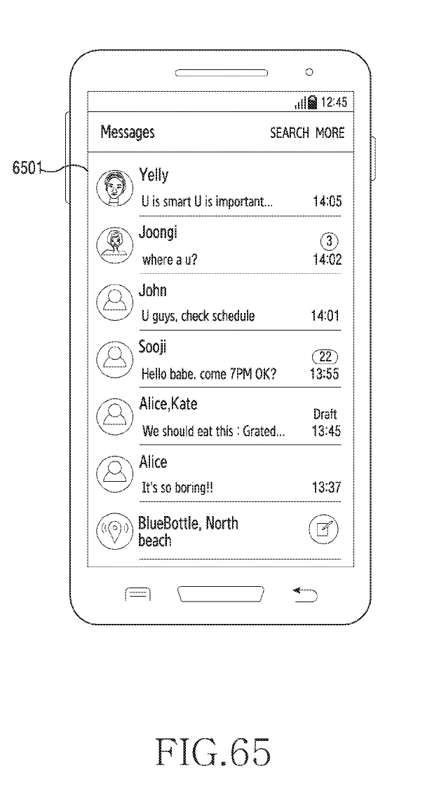

In response to receiving a user input 6307 within the ending notification message 6305, the control unit 409 may, as shown in FIG. 64, display an ending message 6405 of once again notifying that the broadcasting is ended. In response to receiving a user input 6407 within the ending message 6405, the control unit 409 may, as illustrated in FIG. 65, display a message application screen 6501. The control unit 409 may delete a thread item from the message application screen 6501, and display only other message items.

A feature, structure, effect, etc. described in the aforementioned embodiment are included in at least one embodiment of the disclosure, and are not necessarily limited only to one embodiment. Further, the feature, structure, effect, etc. illustrated in each embodiment are possible to be combined or modified and embodied even for other embodiments by a person having ordinary skill in the art to which the embodiments pertain. Accordingly, substance related with this combination and modification should be construed as being included in the scope of the disclosure.

Also, the above description has been made focusing on the embodiments, but this is just an example and does not limit the disclosure, and it will be able to be appreciated by a person having ordinary skill in the art to which the disclosure pertains that various modifications and applications not illustrated above are possible without departing from intrinsic characteristics of the present embodiment. For example, each constituent element shown in detail in embodiments may be modified and embodied. And, differences related with this modification and application should be construed as being included in the scope of the disclosure prescribed by the accompanying claims.

1. An operation method of an electronic device, comprising:
connecting to a relay device by using a near field communication; and
transmitting, via the relay device, a message to an external device which is previously connected to the relay device by using the near field communication.

2. The operation method of claim 1, further comprising:
writing the message; and
identifying a connection with the relay device.

3. The operation method of claim 2, wherein identifying the connection with the relay device further comprises outputting a connectable relay device list.

4. The operation method of claim 1, further comprising displaying a thread which the message belongs to and the message.

5. The operation method of claim 1, further comprising:
receiving a message; and
displaying a thread which the received message belongs to and the received message.

6. The operation method of claim 4, wherein the displaying further comprises:
identifying thread information and message information that are comprised in the message;
identifying a message type and a matching message matched with the message, based on the message information; and
identifying a matching thread matched with the thread information, based on the thread information.

7. The operation method of claim 6, wherein displaying the thread comprises displaying the matching thread.

8. The operation method of claim 6, wherein displaying the message comprises displaying the message according to the message type.

9. The operation method of claim 8, wherein the message comprises a first type message and a second type message, and
in the displaying, the first type message is displayed within the identified matching thread, and the second type message is displayed within the identified matching message.

10. The operation method of claim 9, wherein the first type message comprises a text, a photo, a voice or a video, and
the second type message is a message comprising interest information about the first type message.

11. An electronic device comprising:
a display unit;
a communication unit functionally connected with the display unit; and
a control unit functionally connected with the display unit and the communication unit,
wherein the control unit is configured to connect to the relay device by using a near field communication, and transmit, via the relay device, a message to external devices which are previously connected with the relay device by using the near field communication.

12. The electronic device of claim 11, wherein the control unit is configured to:
write the message, and
identify a connection with the relay device.

13. The electronic device of claim 11, wherein the control unit is further configured to display a thread which the message belongs to and the message on the display unit.

14. The electronic device of claim 11, wherein the control unit is further configured to:
receive a message, and
display a thread which the received message belongs to and the received message.

15. The electronic device of claim 13, wherein the control unit is further configured to:
identify thread information and message information that are comprised in the message,
identify a message type and a matching message matched with the message, based on the message information, and
identify a matching thread matched with the thread, based on the thread information.

16. The electronic device of claim 12, wherein the control unit is further configured to output a connectable relay device list.

17. The electronic device of claim 15, wherein the control unit is configured to display the matching thread.

18. The electronic device of claim 15, wherein the control unit is configured to display the message according to the message type.

19. The electronic device of claim 18, wherein the message comprises a first type message and a second type message, and
wherein the control unit is configured to:
display the first type message within the identified matching thread, and
display the second type message within the identified matching message.

20. The electronic device of claim 19, wherein the first type message comprises a text, a photo, a voice or a video, and
the second type message is a message comprising interest information about the first type message.
